(19) United States
(12) Patent Application Publication
(10) Pub. No.: US 2026/0034793 A1
(43) Pub. Date: Feb. 5, 2026

(54) LIQUID SUPPLY APPARATUS, CONTROL METHOD, AND SYSTEM

(71) Applicant: CANON KABUSHIKI KAISHA, Tokyo (JP)

(72) Inventors: HIROMASA YONEYAMA, Kanagawa (JP); DAIGO KURONUMA, Kanagawa (JP); HIDEYUKI NOZAWA, Tochigi (JP); TOMOYUKI NAGASE, Kanagawa (JP); NAOAKI WADA, Kanagawa (JP); MASAKAZU NAGASHIMA, Kanagawa (JP); RYOHEI MARUYAMA, Kanagawa (JP); KICHINOSUKE HIROKAWA, Tokyo (JP); KENTA IIMURA, Tokyo (JP); AKIRA FUJIKAKE, Kanagawa (JP); YUTO NITAMI, Kanagawa (JP); KENGO NIEDA, Kanagawa (JP)

(21) Appl. No.: 19/351,180

(22) Filed: Oct. 6, 2025

Related U.S. Application Data
(63) Continuation of application No. PCT/JP2024/016269, filed on Apr. 25, 2024.

(30) Foreign Application Priority Data
Apr. 28, 2023 (JP) 2023-074957
Apr. 23, 2024 (JP) 2024-069954

(51) Int. Cl. B41J 2/175

(52) U.S. Cl. CPC B41J 2/17513; B41J 2/17553; B41J 2/17566; B41J 2002/17516

(57) ABSTRACT

A liquid supply apparatus includes a support unit configured to support a liquid container having flexibility, a channel forming unit configured to be connected to the liquid container supported by the support means, and form a channel through which liquid flows from the liquid container to a supply destination, and pressing unit configured to repeat a pressing operation and a pressing reduced operation with respect to the liquid container supported by support unit.

### CROSS-REFERENCE TO RELATED APPLICATIONS

This application is a Continuation of International Patent Application No. PCT/JP2024/016269, filed Apr. 25, 2024, which claims the benefit of Japanese Patent Application No. 2023-074957 filed Apr. 28, 2023 and Japanese Patent Application No 2024-069954 filed Apr. 23, 2024, which are hereby incorporated by reference herein in their entirety.

### BACKGROUND

### Field of the Technology

The present disclosure relates to a liquid supply apparatus, a control method, and a system.

### Description of the Related Art

Flexible liquid containers are known as a method of storing a liquid. Such liquid containers can be used as liquid containers for storing ink, for example. Japanese Patent Laid-Open No. 2020-131648 discloses an apparatus for printing an image by supplying ink from a bag-shaped ink container to a printing apparatus.

The liquid stored in a liquid container may undergo component separation over time. For example, ink may include coloring materials, and these coloring materials may settle within the liquid container. If such ink is supplied to a printing apparatus as is, the quality of the printed image may be lower.

### SUMMARY

The present disclosure provides a technique for improving uniformity of a liquid stored in a liquid container.

According to an aspect of the present disclosure, there is provided a liquid supply apparatus comprising: a support unit configured to support a liquid container having flexibility; a channel forming unit configured to be connected to the liquid container supported by the support unit, and form a channel through which liquid flows from the liquid container to a supply destination; and a pressing unit configured to repeat a pressing operation and a pressing reduced operation with respect to the liquid container supported by the support unit.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a system according to one embodiment of the present disclosure.

FIG. 2A is a front view of the system of FIG. 1.

FIG. 2B is an explanatory view illustrating an internal structure of a liquid discharge apparatus.

FIG. 3 is a partially exploded perspective view of a liquid supply apparatus.

FIG. 4 is a perspective view of a liquid container and a support unit.

FIG. 5 is an explanatory view of operation of a handle and a lock mechanism.

FIG. 6 is an explanatory view of operation of the lock mechanism.

FIG. 7 is a diagram illustrating a mounting orientation and insertion and removal states of support units with respect to slots.

FIG. 8 is an explanatory view of operation of a pressing unit.

FIG. 9 is an explanatory view of operation of the pressing unit.

FIG. 10 is an explanatory view of a cam.

FIG. 11 is a perspective view of a case with a mixing function and a support unit in a separated state.

FIG. 12 is a perspective view of a case with a mixing function and a support unit in a mounted state.

FIG. 13A is an explanatory view of a mixing operation.

FIG. 13B is an explanatory view of a mixing operation.

FIG. 14A is a front view of the liquid supply apparatus.

FIG. 14B is a front view of another example of the liquid supply apparatus.

FIG. 15 is a block diagram of a control circuit of the system of FIG. 1.

FIG. 16A is a flowchart indicating an example of processing performed by a control unit of the liquid discharge apparatus.

FIG. 16B is a flowchart indicating an example of processing performed by a control unit of the liquid discharge apparatus.

FIG. 17A is a flowchart indicating an example of processing performed by the control unit of the liquid discharge apparatus.

FIG. 17B is a flowchart indicating an example of processing performed by the control unit of the liquid discharge apparatus.

FIG. 18 is an explanatory view of another example of the pressing member.

FIG. 19 is an explanatory view of another example of the pressing member.

FIG. 20 is an explanatory view of a pressing location with respect to the liquid container.

FIG. 21A is an explanatory view of another example of the pressing member.

FIG. 21B is an explanatory view of another example of the pressing member.

FIG. 22A is an explanatory view of another example of the pressing member.

FIG. 22B is an explanatory view of another example of the pressing member.

FIG. 23A is a diagram illustrating another example of the liquid container.

FIG. 23B is an explanatory view of another example of the pressing member.

FIG. 24A is an explanatory view of operation of the pressing member of FIG. 23B.

FIG. 24B is an explanatory view of operation of the pressing member of FIG. 23B.

FIG. 25 is a diagram illustrating another example of the liquid container.

FIG. 26 is a diagram illustrating another example of the liquid container.

FIG. 27 is an explanatory view of another example of a slot.

FIG. 28 is an explanatory view of another example of a slot.

FIG. 29 is an explanatory view of another example of a slot.

FIG. 30 is an explanatory diagram of another example of the slot and the pressing member.

FIG. 31 is an explanatory view of another example of the pressing member.

FIG. 32A is a cross-sectional view taken along line B-B of FIG. 31.

FIG. 32B is a cross-sectional view taken along line C-C of FIG. 31.

FIG. 33 is an explanatory view of the pressing member of FIG. 31.

FIG. 34A is a cross-sectional view taken along line D-D of FIG. 33.

FIG. 34B is a cross-sectional view taken along line E-E of FIG. 33.

FIG. 34C is a cross-sectional view taken along line F-F of FIG. 33.

FIG. 35 is an explanatory view of the pressing member of FIG. 31.

FIG. 36A is a cross-sectional view taken along line G-G of FIG. 35.

FIG. 36B is a cross-sectional view taken along line H-H of FIG. 35.

FIG. 36C is a cross-sectional view taken along line I-I of FIG. 35.

FIG. 37 is an explanatory view of another example of the pressing member.

FIG. 38 is an explanatory view of the pressing member of FIG. 37.

FIG. 39A is a cross-sectional view taken along line J-J of FIG. 38.

FIG. 39B is a cross-sectional view taken along line K-K of FIG. 38.

FIG. 39C is a cross-sectional view taken along line L-L of FIG. 38.

FIG. 40 is an explanatory view of a mixing operation in an example of another configuration of the pressing unit.

FIG. 41 is a diagram illustrating an example of another configuration of the pressing unit.

FIG. 42 is an explanatory view of a mixing operation in an example of the configuration of FIG. 41.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

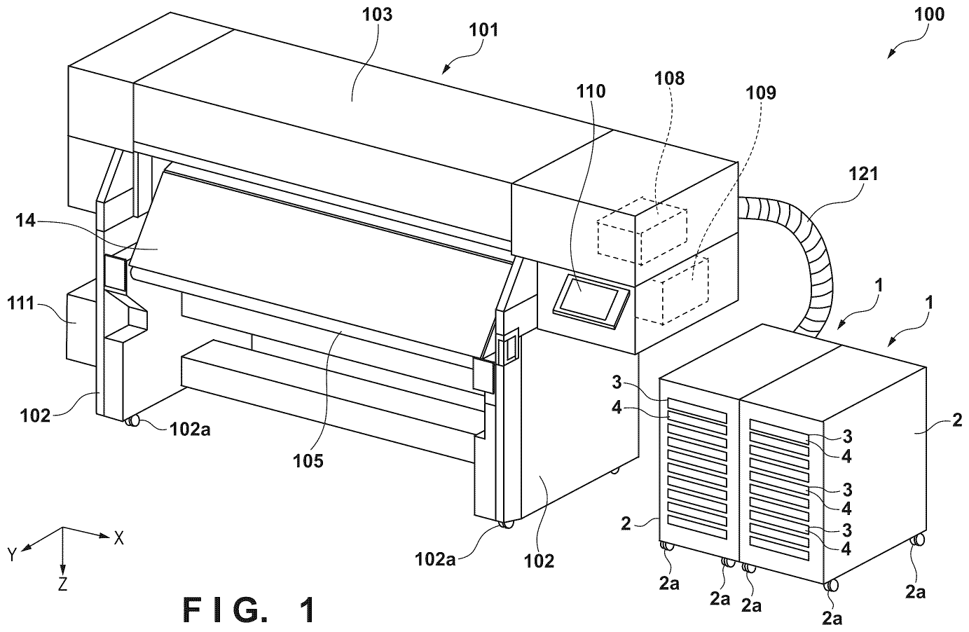

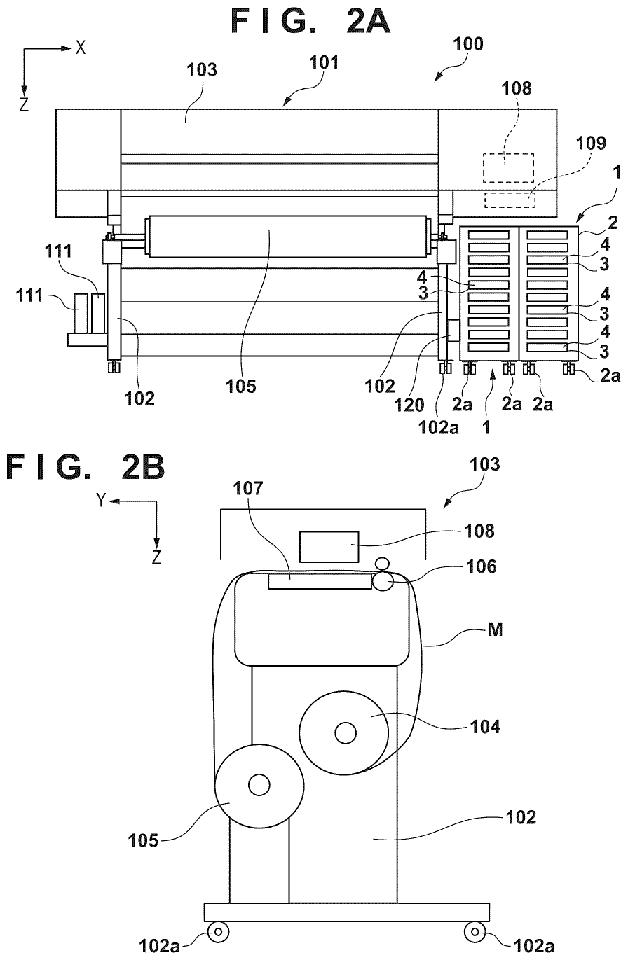

FIG. 1 is a perspective view of a system 100 according to one embodiment of the present disclosure, and FIG. 2A is a front view of the system 100. In each figure, arrows X, Y, and Z indicate directions intersecting each other and, in the case of the present embodiment, are orthogonal. Assume that a left-right direction when the system 100 is installed on a horizontal plane is an X direction, a front-back direction is a Y direction, and an up-down direction is a Z-direction. Further, assume that a right side when the system 100 is viewed from the front is a +X direction, a left side is a −X direction, a near side is a +Y direction, a far side is a −Y direction, a down side (downward in the direction of gravity) is a +Z direction, and an up side (upward in the direction of gravity) is a −Z direction.

The system 100 of the present embodiment is a printing system that includes liquid supply apparatuses 1 and a liquid discharge apparatus 101 and prints an image by discharging ink onto a printing medium, such as paper. The liquid supply apparatus 1 is a liquid storage apparatus in that it stores liquids. In the case of the present embodiment, two liquid supply apparatuses 1 are provided so as to be connected to each other. The liquid discharge apparatus 101 and the two liquid supply apparatuses 1 are arranged so as to be aligned in the X direction. The liquid that the liquid supply apparatus 1 supplies to the liquid discharge apparatus 101 is ink, and the liquid discharge apparatus 101 is a printing apparatus that discharges ink onto a printing medium. However, the present disclosure is not limited to a printing system and is applicable to various types of liquid discharge systems for discharging a liquid onto a medium.

“Printing” includes not only cases of forming meaningful information, such as characters and shapes, but also cases of forming images, designs, patterns, and the like widely on a printing medium regardless of meaningfulness or of processing a medium, and it does not matter whether these are actualized so as to be visually perceivable by a human. In addition, although sheet-like paper is assumed as a “printing medium” in the present embodiment, it may be cloth, plastic film, or the like.

### <Liquid Discharge Apparatus>

The liquid discharge apparatus 101 will now be described with reference to FIG. 2B in addition to FIGS. 1 and 2A. FIG. 2B is an explanatory view of an internal structure of the liquid discharge apparatus 101. The liquid discharge apparatus 101 includes a pair of left and right stands 102 and a body 103 supported on the pair of stands 102. Each stand 102 is provided with casters 102a, and the liquid discharge apparatus 101 can be moved relatively easily on the floor. A feeding unit 104 and a winding unit 105 are arranged below the body 103. In the present embodiment, a printing medium M is rolled paper, and the feeding unit 104 includes a shaft on which the printing medium M is wound. The winding unit 105 includes a shaft for winding the printing medium M. In the case of the present embodiment, rolled paper is given as an example of the printing medium M, but it may be cut paper.

A conveyance unit 106 is provided in the body 103. The conveyance unit 106 includes a driving roller and a driven roller and sandwiches a printing medium M fed from the feeding unit 104 in a nip portion of the rollers. The printing medium M is conveyed on a platen 107 by rotation of the driving roller. A discharge head 108 is arranged so as to face the platen 107. The discharge head 108 is a printhead that discharges ink to form an image. An image is printed on the printing medium M conveyed on the platen 107 by the discharge head 108 discharging ink on the printing medium M.

The discharge head 108 includes, for example, discharge energy generation elements, such as electro-thermal conversion elements (heaters) or piezo elements, and discharges ink from a discharge port. When electro-thermal conversion elements are used, the heat thereof causes ink to bubble, and using the bubble energy, ink can be discharged from discharge ports. The printing method of the discharge head 108 may be a serial scan method or a full line method. In the case of the serial scan method, the discharge head 108 is mounted on a carriage and moves back and forth in the X direction. The discharge head 108 discharging ink while moving in the X direction is called print scanning. The conveyance operation of the printing medium M and the print scanning of the discharge head 108 are alternately repeated to print an image on the printing medium M. In the case of the present embodiment, assume that the serial scan method is employed. In the case of the full line method, a long discharge head 108 extending in the X direction is used, and an image is printed while continuously conveying the printing medium M.

The printing medium M on which an image has been printed is wound by the winding unit 105. A drying unit 14 reduces the liquid components included in the ink applied onto the printing medium M by the discharge head 108 and increases the fixation between the printing medium M and the ink. The drying unit 14 includes a heat source such as a heater and an air blowing mechanism such as a fan, and dries the printing medium M by applying hot air to the passing printing medium M at least from the ink applied side. In addition to the hot air application method, the drying method may also be configured by combining a method of irradiating the surface of the printing medium M with electromagnetic waves (e.g., ultraviolet or infrared) and a method of conductive heat transfer through contact with a heating element. Further, the drying unit 14 may be configured to perform only air blowing without including a heat source. The printing medium M on which an image has been printed is cut by a user using scissors or the like or is automatically cut by a cutter (not illustrated).

A recovery unit 109 is arranged in the body 103. The recovery unit 109 is arranged outside a printing region (outside a discharge region) of the discharge head 108 and performs processing related to recovery and maintenance of the discharge performance of the discharge head 108. For example, preliminary discharge in which a predetermined amount of ink is discharged before and after a printing operation or processing for suctioning remaining ink or the like from the discharge ports of the discharge head 108 can be given as such processing. The discharge head 108 is moved above the recovery unit 109 when the recovery processing is needed, as illustrated in FIG. 2A.

In the present embodiment, the stands 102 support the heavy feeding unit 104 and winding unit 105 while supporting the body 103 and thus are arranged at positions slightly outside the width of the printing medium M in the +X directions. In addition, the form is such that the body 103 in which the recovery unit 109 is incorporated protrudes on an outer side in the +X direction than the stand 102. The body 103 also takes a form in which it protrudes to an outer side of the printing medium M on the opposite, −X direction side. Here, a mechanism or the like for moving the carriage (not illustrated) on which the discharge head 108 is mounted is incorporated.

An operation panel 110 is provided on the front surface of the body 103. The operation panel 110 is, for example, a touch panel and can accept input of various settings related to printing, display the status of a print job, and the like.

The liquid discharge apparatus 101 is also provided with waste liquid cartridges 111. The waste liquid cartridges 111 are arranged below an end portion of the body 103 on a side (−X side) opposite to the liquid supply apparatus 1. By installing the waste liquid cartridges 111 below the portion of the body 103 protruding to the −X side, the installation area of the liquid discharge apparatus 101 can be reduced.

A waste liquid (waste ink or the like) suctioned by the recovery unit 109 flows into and is collected in the waste liquid cartridge 111. The waste liquid cartridges 111 may be arranged near the recovery unit 109. However, in the present embodiment, the waste liquid cartridges 111 are arranged in an empty space below the end portion of the body 103 to reduce the installation area of the liquid discharge apparatus 101.

### <Liquid Supply Apparatus>

FIGS. 1 and 2A are referred to. The liquid supply apparatus 1 is an apparatus for supplying ink to be discharged from the discharge head 108 to the liquid discharge apparatus 101. The liquid supply apparatus 1 includes a box-shaped body 2 in which a plurality of slots 3 are formed. Casters 2a are provided on the bottom surface of the body 2, and the liquid supply apparatus 1 can be moved relatively easily on the floor. The plurality of slots 3 are opened in an outer wall portion 2b on the front side of the body 2, and the plurality of slots 3 are arranged in the Z direction. The outer wall portion 2b forms the housing of the body 2. A support unit 4 is inserted in each slot 3 so as to be attachable and detachable in the Y direction. The support unit 4 supports a liquid container 200 (also simply referred to as a container 200) to be described later. Each slot 3 functions as a storage portion of the container 200.

Each slot 3 is provided with a tube for connecting the container 200 and the liquid discharge apparatus 101. Each tube is connected to the liquid discharge apparatus 101 through a single hose 121 storing all the tubes. The ink in the container 200 is supplied to the discharge head 108 via a tube.

The height of the liquid supply apparatus 1 is set to be lower than the bottom surface of the end portion of the body 103 protruding to the +X side of the liquid discharge apparatus 101. Therefore, as in FIG. 2A, the liquid supply apparatuses 1 can fit below the body 103. The liquid supply apparatuses 1 can be brought closer in the X direction up to a position at which they come into contact with the stand 102. As illustrated in FIG. 2A, the liquid supply apparatuses 1 may be secured to the stand 102, using a coupling member 120. When moving the system 100, the liquid discharge apparatus 101 and the liquid supply apparatuses 1 can be moved as a unit.

The system 100 of the present embodiment is provided with two liquid supply apparatuses 1 and thus can use more containers 200. When increasing the number of ink colors for image quality improvement or increasing the number of inks of the same color for increased productivity, it is advantageous that a plurality of liquid supply apparatuses 1 are provided as such. In such a case, by employing a layout in which some or all of the liquid supply apparatuses 1 overlap with the liquid discharge apparatus 101 in the X direction as in the present embodiment, the installation area of the system 100 can be reduced. In the case of the present embodiment, one of the two liquid supply apparatuses 1 fits within the size of the liquid discharge apparatus 101 in the X direction. The size relationship is such that when there are two or more units, they slightly protrude from the system 100 in the X direction.

### (Liquid Container and Support Unit)

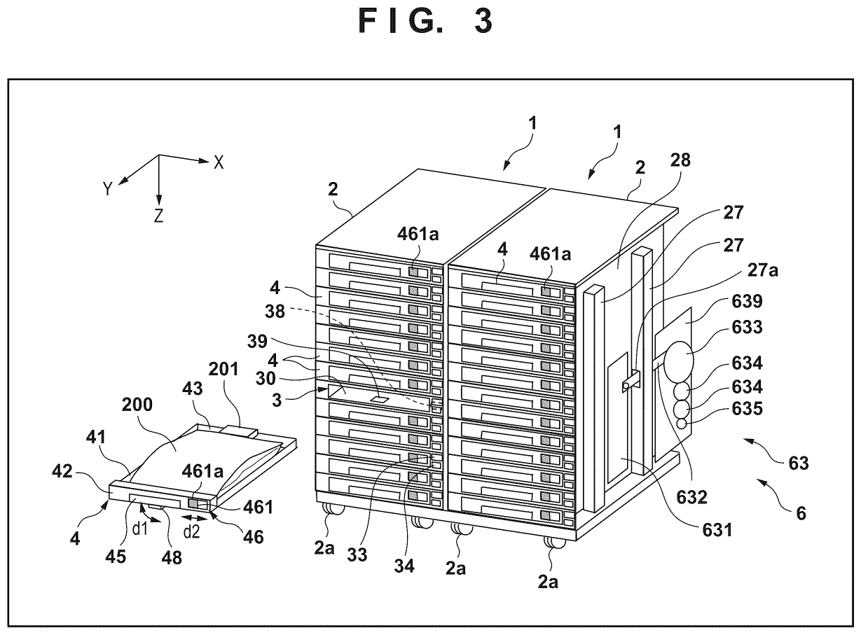

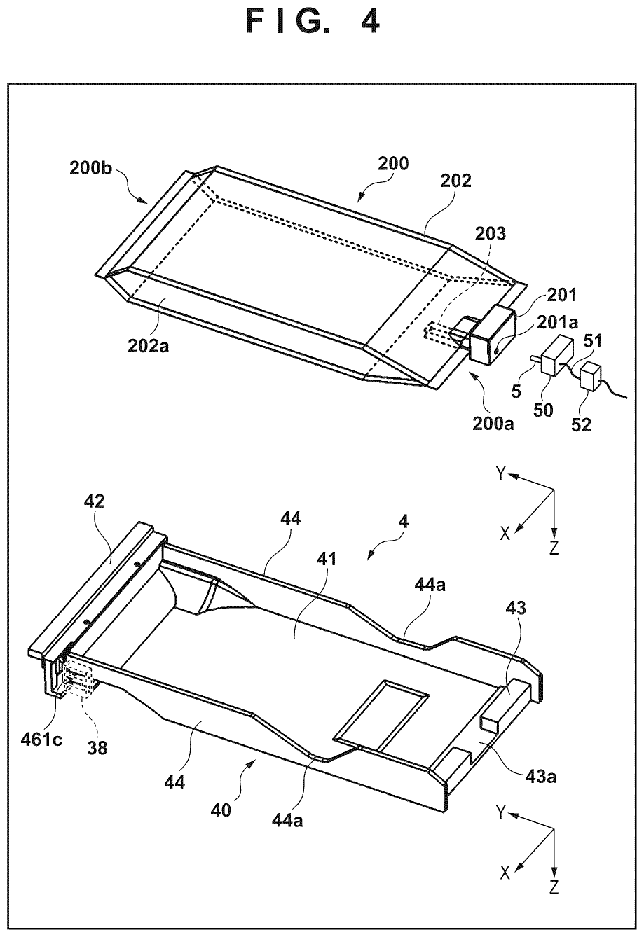

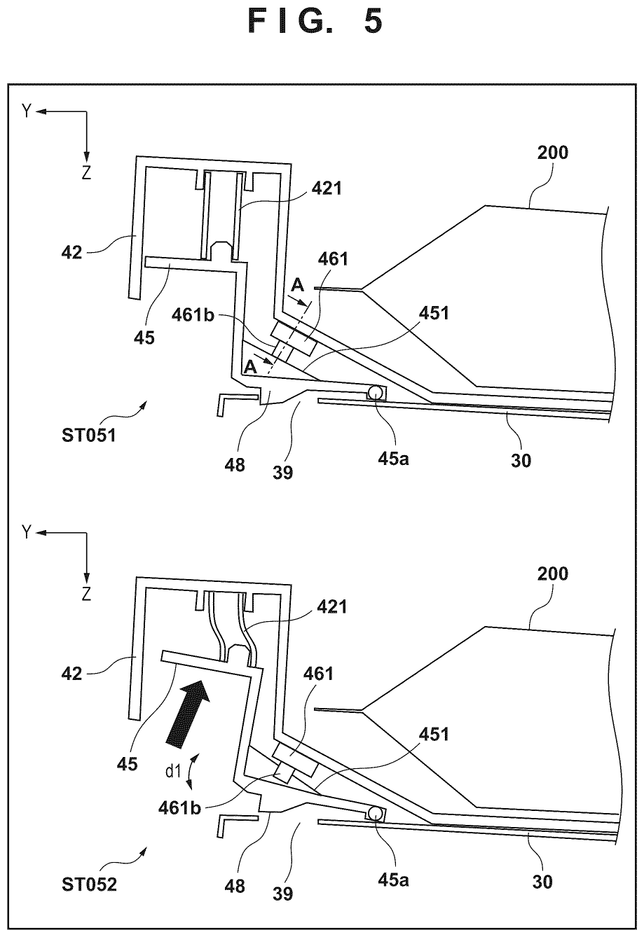

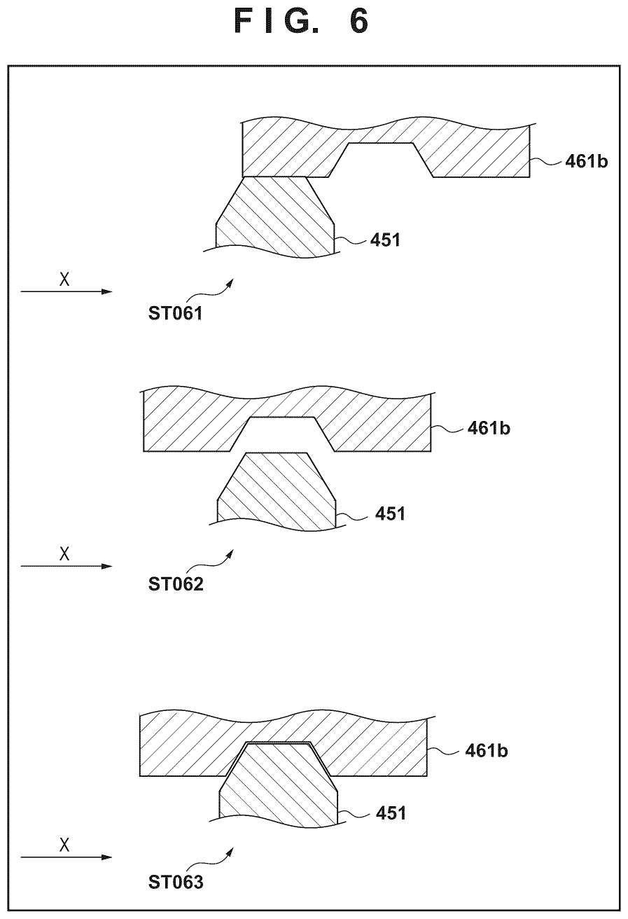

FIGS. 3 to 6 are referred to. FIG. 3 is a partially exploded perspective view of the liquid supply apparatuses 1 and illustrates a state in which one support unit 4 has been removed from a corresponding slot 3. Further, FIG. 3 illustrates a state in which a part of a side wall portion of the outer wall portion of the liquid supply apparatus 1 has been removed and an internal mechanism is exposed. FIG. 4 is a perspective view of the container 200 and the support unit 4. FIG. 5 is an explanatory view of operation of a handle 45 and a lock mechanism 46. FIG. 6 is an explanatory view of operation of the lock mechanism 46 and correspond to cross-sectional views taken along line A-A of FIG. 5.

The container 200 includes a bag 202 formed of a flexible material. Both side surfaces of the bag 202 are provided with an inwardly-folded gusset portion 202a for increasing liquid capacity. The bag 202 is formed in a bag shape by welding respective sheets constituting the top and bottom surfaces and sheets forming the gusset portions 202a to each other, and the bag 202 forms a flexible tank for storing a liquid. When the amount of liquid remaining inside is large, the gusset portions 202a expand, and when it is small, the gusset portions 202a fold in; the shape of the bag 202 changes according to the amount of liquid stored. The material of the bag 202 is, for example, a material having a multilayered structure, such as PET. If the liquid inside has a property of reacting with air and solidifying or there is a concern that the density or the remaining amount changes due to evaporation, a layer material including an aluminum layer is advantageous as a material of the bag 202.

The container 200 includes one end portion 200a and the other end portion 200b in a lengthwise direction. While mounted in the liquid supply apparatus 1, the end portion 200a is positioned on the far side of the liquid supply apparatus 1, and the end portion 200b is positioned on the near side. The end portion 200a is provided with an outlet member 201. Regarding the outlet member 201, a supply port 201a connected with an intake port 203 in the bag 202 is formed. The liquid stored in the bag 202 flows out through the intake port 203 and the supply port 201a. A spring biased supply port on-off valve for opening and closing the supply port 201a is provided in the outlet member 201. At normal times, the supply port 201a is kept closed by the supply port on-off valve.

Regarding the container 200, the length of the side on which the outlet member 201 is provided is, for example, about 180 mm, and the length of the side (side surface) orthogonal thereto is, for example, about 400 mm. The container 200 contains, for example, a liquid of about 1.5 L. The side on which the outlet member 201 is present may be the longer side rather than the shorter side. Further, the bag 202 may be square rather than rectangular in planar view.

The body 2 includes needle-type channel forming members 5 to be inserted into the supply ports 201a on the far side of the slots 3. The channel forming member 5 is provided for each slot 3. When the channel forming member 5 is inserted into the supply port 201a and a connected state is established, the supply port on-off valve enters an open state by the channel forming member 5 being inserted. The channel forming member 5 is supported by a block-shaped support member 50 and is also connected to a tube 51. The channel forming member 5 forms a channel for the liquid stored in the bag 202 to flow to the liquid discharge apparatus 101, which is the supply destination, and the liquid that flowed to the channel forming member 5 is supplied to the liquid discharge apparatus 101 via the tube 51. An electric channel valve 52 is provided in a midway portion of the tube 51. The tube 51 can be opened and closed by the channel valve 52 being opened and closed.

The support unit 4 includes a support portion 40 for supporting the container 200 and, as a whole, has a form of a tray on which the container 200 in a lying orientation is to be placed. The support unit 4 is displaceable in a substantially Y direction between a storage position in which the container 200 is stored in the body 2 and a removal position in which the container 200 is exposed to the outside of the body 2. Regarding FIG. 3, one support unit 4 is positioned in the removal position, and the other support units 4 are all positioned in the storage positions. In the removal position, the container 200 can be replaced, and in the storage position, the liquid stored in the container 200 can be supplied to the liquid discharge apparatus 101. In the present embodiment, the support unit 4 is separated from the slot 3 in the removal position. However, the removal position may be a position in which the end portion of the support unit 4 is held in the slot 3 and need only be a position in which the container 200 can be replaced for the support unit 4.

The support portion 40 includes a placement surface 41 on which the container 200 is to be placed, and the four sides of the placement surface 41 are defined by left and right side plates 44, a front end portion 42, and a back end portion 43. A notch portion 44a is formed in the side plate 44. A recess 43a in which the outlet member 201 is to be arranged is formed in the back end portion 43.

A handle 45, which can be rotated about a shaft 45a extending in the X direction, is provided at the front end portion 42, and the user can rotate the handle 45 in a d1 direction. The handle 45 also serves as an operation handle of an engaging portion 48. The handle 45 is provided with the engaging portion 48, and an engaging portion 39 for engaging with the engaging portion 48 is formed in the bottom portion of a case 30 forming the slot 3. In the present embodiment, the engaging portion 48 is a convex portion, and the engaging portion 39 is a concave portion into which the engaging portion 48 is to be inserted. The support unit 4, which is mounted in the slot 3 by the engaging portion 48 and the engaging portion 39 engaging and positioned in the storage position, can be prevented from falling out of the slot 3 even if vibration is applied by the liquid supply apparatus 1 moving or the like, for example. The handle 45 is biased toward a side of the engaged position (position of state ST051 FIG. 5) at which the engaging portion 48 and the engaging portion 39 are engaged by an elastic member 421 at all times. The elastic member 421 is, for example, a coil spring. When the user holds the handle 45 and rotates the handle 45 in a direction indicated by an arrow in a state ST052 of FIG. 5, the engagement between the engaging portion 48 and the engaging portion 39 is released, and the support unit 4 inserted into the slot 3 can be removed from the slot 3.

To prevent the support unit 4 mounted in the slot 3 from being inadvertently removed, the lock mechanism 46 for locking the support unit 4 in the storage position is provided for each slot 3. The lock mechanism 46 includes a sliding member 461 incorporated into the front end portion 42. Regarding the sliding member 461, an operation portion 461a which is a part thereof is exposed from the front end portion 42 so as to be operable by the user. The sliding member 461 is provided so as to be able to move in a direction of an arrow d2 (X direction) between a locked position in which the rotation of the handle 45 in the d1 direction is restricted and an unlocked position in which the rotation of the handle 45 is allowed.

The state ST051 of FIG. 5 and a state ST061 of FIG. 6 indicate a state in which the sliding member 461 is positioned in the locked position. That is, the lock mechanism 46 is in a locked state. The sliding member 461 includes a contact portion 461b, and the contact portion 461b contacts a contact portion 451 provided in a rib shape on the handle 45. In the state ST051 of FIG. 5 and the state ST061 of FIG. 6, the handle 45 cannot be rotated in a disengagement direction due to the sliding member 461 being in the way. Therefore, the support unit 4 cannot be removed from the slot 3.

A state ST062 of FIG. 6 indicates a state in which the sliding member 461 is positioned in the unlocked position. That is, the lock mechanism 46 is in an unlocked state. A notch portion of the contact portion 461b and the contact portion 451 are in opposing positions. At this time, the contact portion 451 can escape into the notch portion of the contact portion 461b as indicated in a state ST063 FIG. 6, and thus, the handle 45 can be rotated in the disengagement direction as indicated in the state ST052 of FIG. 5. By the user thus operating the handle 45 after sliding the sliding member 461 to the unlocked position, the support unit 4 can be drawn out of the slot 3.

Next, the slot 3 is provided with a sensor 38 for detecting the position of the sliding member 461. The sensor 38 is, for example, an optical sensor (e.g., photo interrupter) capable of detecting a detection piece 461c of the sliding member 461. If the sliding member 461 is positioned in the locked position, the detection piece 461c will be positioned in a detection position of the sensor 38 as illustrated in FIG. 4 and thus will be detected by the sensor 38. If the sliding member 461 is positioned in the unlocked position, the detection piece 461c will not be positioned in the detection position of the sensor 38 and thus will not be detected by the sensor 38. It can thus be determined whether the position of the sliding member 461 is the locked position or the unlocked position, that is, whether the lock mechanism 46 is in a locked state or an unlocked state, based on the detection result of the sensor 38.

It is possible to coordinate the opening and closing of the channel valve 52 with the detection result of the sensor 38. For example, if the channel valve 52 is in an open state, when it is detected that the position of the sliding member 461 is in the unlocked position by the sensor 38, the channel valve 52 is immediately closed in coordination with the detection. In doing so, it is possible to prevent the support unit 4 from being drawn out from the slot 3 while the channel valve 52 is open. If the support unit 4 is drawn out from the slot 3 while the channel valve 52 is open, air may enter the tube 51 from the channel forming member 5. This causes problems such as solidification of the liquid in the tube 51 and discharge failure in the discharge head 108. When it is detected that the position of the sliding member 461 is in the unlocked position, by immediately closing the channel valve 52 according to automatic control in coordination with the detection, it is possible to avoid a situation in which air enters the tube 51.

### (Slot Inclination)

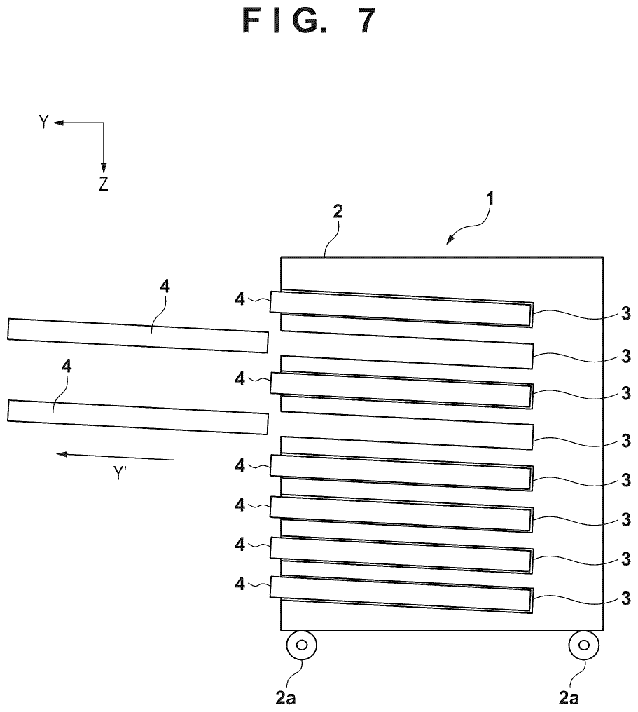

FIG. 7 is a diagram illustrating a mounting orientation and insertion and removal states of the support units 4 with respect to the slots 3.

The slot 3 of each level provided in the liquid supply apparatus 1 as illustrated in FIG. 7 is inclined and lowers toward the downward (+Z) side as it approaches the back side (far side; −Y side). Accordingly, the support unit 4 is held in an inclined orientation in the mounted state, and the container 200 is positioned such that the end portion 200a is lower in the direction of gravity (Z direction) than the end portion 200b. The effect thereof will be described later; the inclination angle is, for example, smaller than 45 degrees, in particular 10 degrees or less, with respect to the horizontal plane. In the example of FIG. 7, 3 degrees is assumed as the inclination angle.

### (Liquid Mixing Mechanism)

Various types of liquids can be stored in the container 200 and utilized for printing images, maintenance of the discharge head 108, and the like. For example, water-based ink, latex ink, and solvent (e.g., eco-solvent)-based ink can be stored in the container 200. Depending on the type of ink, a coloring material (e.g. pigment component) in the ink may settle over time. The particle size of the coloring material and the type and amount of additive material may be different for each color of the ink, and the settling speed may vary depending on the ink color. In addition, a reactive liquid that is discharged from the discharge head 108 and reacts with ink to fix the ink on the surface of the printing medium M can also be stored in the container 200. Regarding the container 200 storing a liquid having a property of components separating, it is possible to improve uniformity by appropriately mixing the stored liquid. This contributes to, for example, preventing the quality of an image to be printed from deteriorating.

In the present embodiment, the bag 202 of the container 200 is deformed by being physically pressed from the outside. Accordingly, the stored liquid flows in the bag 202 and is thus mixed. Depending on the liquid stored in the container 200, some types may not require mixing. Accordingly, in the present embodiment, the slots 3 in which the mixing function is provided and the slots 3 in which the mixing function is not provided are provided. Specifically, the upper slots 3 are not provided with the mixing function, and the middle to lower slots 3 are provided with the mixing function. Of course, all the slots 3 may be provided with the mixing function.

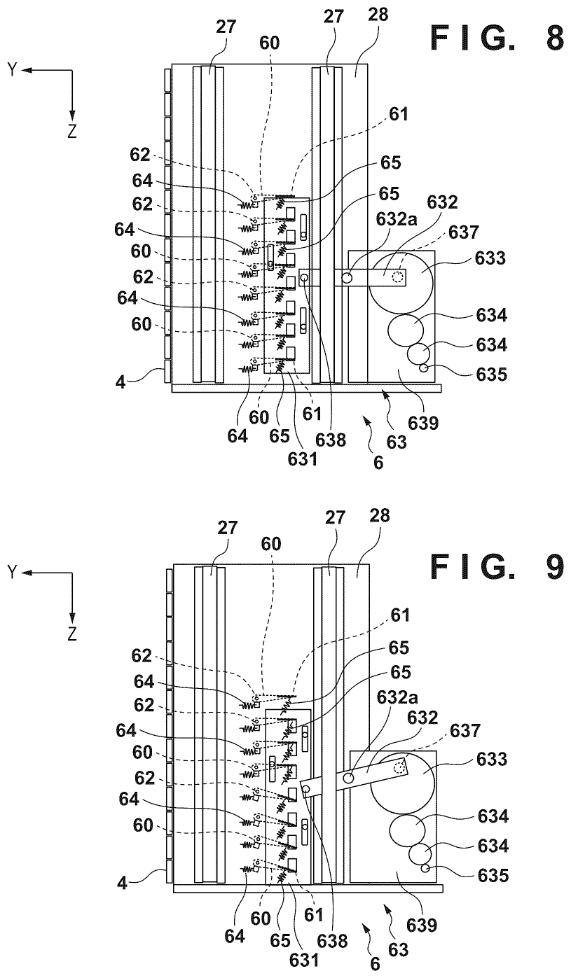

A configuration of a pressing unit 6 which realizes the mixing function will be described with reference to FIGS. 3, 8 and 9. FIGS. 8 and 9 are explanatory views of operation of the pressing unit 6 when viewing the body 2 from the side. The pressing unit 6 includes a plurality of pressing members 60, and a moving mechanism 63 common to the plurality of pressing members 60. The pressing member 60 is provided for each slot 3. The pressing member 60 is arranged at a position facing the support unit 4 mounted in the slot 3 and the container 200 supported by the support unit 4. The moving mechanism 63 synchronously rotates each pressing member 60 with a rotation shaft 62 as the rotation center such that a pressing portion 61 provided in the pressing member 60 presses the container 200 from above and then reduces the pressure. FIG. 8 illustrates a state in which the pressing portions 61 (and the pressing members 60) are in a pressing reduced position, and FIG. 9 illustrates a state in which the pressing portions 61 (and the pressing members 60) are in a pressing position.

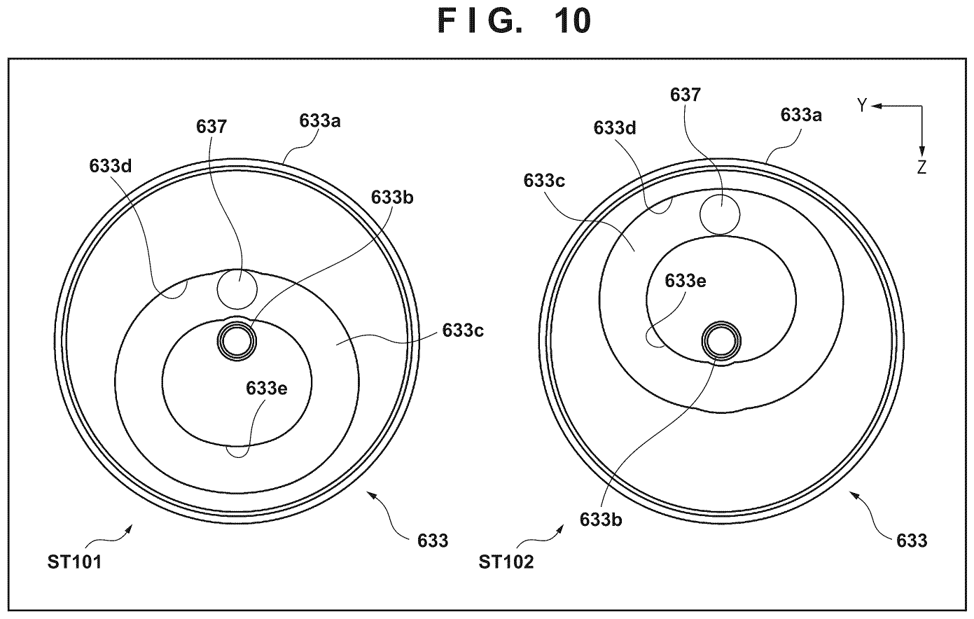

The configuration of the moving mechanism 63 will be described. The output of a motor 635 which is a driving source of the moving mechanism 63 is transmitted to a cam 633 via a plurality of gears 634. The rotation axis of each of these components is the X direction. Here, a configuration of the cam 633 will be described with reference to FIG. 10. FIG. 10 is an explanatory view of the cam 633, and a state ST101 FIG. 10 indicates a state in which the cam 633 has rotated by 180 degrees from a state ST102 of FIG. 10.

The cam 633 is a disc-shaped member that can rotate about a shaft 633b in the X-direction, and a gear teeth portion 633a is formed on the outer peripheral surface thereof. The gear teeth portion 633a is engaged with the gear 634, and the cam 633 is rotated by the rotation of the gear 634. A groove 633c is formed on a side surface of the cam 633, and the respective side surfaces on the outer and inner sides of the groove 633c form an outer cam surface 633d and an inner cam surface 633e. A cam follower 637 coupled with a drive transmission lever 632 is arranged in the groove 633c. The inner cam surface 633c is on the inner side of the cam follower 637 in a radial direction of the cam 633 and serves to contact the cam follower 637 when the cam 633 rotates and thus lift the cam follower 637. The outer cam surface 633d is on the outer side of the cam follower 637 in the radial direction of the cam 633 and serves to contact the cam follower 637 when the cam 633 rotates and thus lower the cam follower 637.

FIGS. 3, 8 and 9 are referred to again. When the cam follower 637 is moved up and down by the rotation of the cam 633, the drive transmission lever 632 rotates about a rotation shaft 632a. The drive transmission lever 632 is connected with a shaft portion 638 provided in a lifting member 631 so as to be rotatable, and thus, the movement of the drive transmission lever 632 is converted into a lifting operation of the lifting member 631. When the cam 633 rotates once, the cam follower 637 performs a reciprocating operation once in the Z direction, and thus, the lifting member 631 similarly performs a reciprocating lifting operation once through the drive transmission lever 632.

The plate-like lifting member 631 is attached so as to be able to move up and down in the Z direction with respect to a side plate 28 of the body 2. Further, two pillars 27 extending in the Z direction, one in the front and the other in the back, each with a U-shaped cross section, are fixed on the side plate 28. Pillars 27 are also attached to a side plate on the −X side, and the strength of the body 2 as a structure is ensured by a total of four pillars 27. This makes it possible to support the weight of a large number of containers 200.

The pillars 27 are strong but are thick, and thus, if the moving mechanism 63 is provided further on the outer side of the pillars 27 attached to the side plate 28 in the X direction, the dimension in the X direction will increase. Therefore, in the present embodiment, the driving mechanism, such as the lifting member 631 and the cam 633, are distributed to the front and back in the Y direction with one of the pillars 27 serving as a boundary. Then, the drive transmission lever 632 passes through a through-hole 27a provided in one of the pillars 27.

By doing so, it is possible to arrange the moving mechanism 63 of the pressing unit 6 so as to prevent the size of the body 2 from increasing in the X direction while ensuring strength. Furthermore, the drive transmission lever 632 is attached to a plate-shaped support member 639 for supporting the moving mechanism 63. By removing a fixing component, such as a fastening screw, most of the structure of the moving mechanism 63 can be removed as a single unit with the support member 639 to the back side of the body 2. Therefore, component replacement or the like can be easily performed by a service person. If the fixing component, such as a fastening screw, is configured to be tightened from the back side of the body 2, fastening and unfastening thereof will be easy.

The biasing forces by two springs 64 and 65 act on a respective pressing member 60. Regarding the spring 64, one end is attached to the pressing member 60, and the other end is attached to the slot 3 (case 30). Further, regarding the spring 65, one end is attached to the pressing member 60, and the other end is attached to the lifting member 631. The pressing member 60 is a movable member (in particular, rotation member) attached so as to be rotatable with respect to the slot 3 (case 30), with the rotation shaft 62 as the rotation center. The rotation shaft 62 is a shaft in a direction intersecting the moving direction (Z direction) of the pressing portion 61. The two springs 64 and 65 both bias the pressing member 60 in a direction of clockwise rotation in FIGS. 8 and 9.

When the pressing members 60 are in the pressing reduced position (FIG. 8), the lifting member 631 is in contact with the pressing members 60 and is lifting itself, and thus the biasing forces by the springs 65 are acting between the lifting member 631 and the pressing members 60. Therefore, the biasing forces of the springs 65 act only between the lifting member 631 and the pressing members 60 and do not burden the motor 635. That is, loads applied to the moving mechanism 63 at the pressing reduced position are only the biasing forces of the springs 64 and the weights of respective components themselves.

Further, when the pressing members 60 are in the pressing position (FIG. 9), the cam 633 is in a phase that is 180 degrees opposite to the pressing reduced position, and the pressing portions 61 of the pressing members 60 are in contact with the containers 200 and are pressing downward. Depending on the amount remaining in the container 200, the pressing distance of the pressing portion 61, that is, the amount of rotation of the pressing member 60 will be different. In FIG. 9, the upper four levels of the pressing members 60 each indicate a state in which they are pressing full containers 200, and the lower four levels of the pressing members 60 each indicate a state in which they are pressing deflated containers 200 with almost no remaining amount. The biasing forces of both the spring 64 and the spring 65 and the weight of each component act on the container 200. Since the springs 64 and 65 are arranged for each slot 3, even if the amount remaining in the container 200 of each slot 3 is different, it is possible to provide each container 200 with an optimal pressing force.

At this time, the biasing force of the spring 64 acts on the container 200 but does not act on the lifting member 631. The biasing force of the spring 65 acts between the container 200 with which it is contacting via the pressing member 60 and the lifting member 631. The cam 633 serves to lower the lifting member 631 downward from the container 200. The two springs 64 and 65 whose attachment positions are different and the cam 633 capable of both lifting and lowering are thus utilized to reduce the load on the moving mechanism 63 during operation.

In the pressing position, the stretch of the spring 64 and the spring 65 is small when the amount remaining in the container 200 is small and the container 200 is less deflated, and thus, the pressing force acting on the container 200 is also reduced. When the amount remaining in the container 200 is large, it is easy to receive a counterforce from the container 200 during pressing, and thus, a larger pressing force is necessary to press farther. On the contrary, when the remaining amount is small, the counterforce from the container 200 is small, and thus, even if the pressing force is small, it is easy to deform the container 200 and move the liquid inside. In other words, the press amount (pressing amount) by which the pressing member 60 presses the container 200 is different depending on the remaining amount of liquid in the container 200. Therefore, the springs 64 and 65 are arranged in positions such that the more the container 200 deflates, the smaller the pressing force will be. By doing so, the biasing force of the spring does not need to be increased unnecessarily. In the present embodiment, the load applied to the pressing portion 61 is adjusted to be, for example, about 500 gf when the container 200 is full and about 300 gf when there is almost no remaining amount.

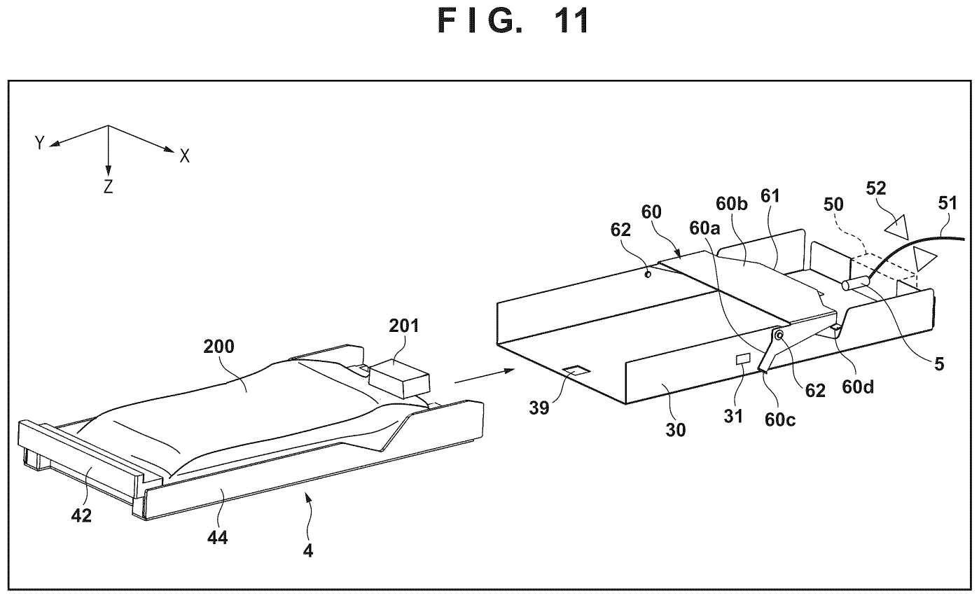

A configuration of the pressing member 60 will be described with reference to FIGS. 11 and 12. FIG. 11 is a perspective view of a case with a mixing function and a support unit in a separated state, and FIG. 12 is a perspective view of a case with a mixing function and a support unit in a mounted state.

The pressing member 60 includes a pair of side plates 60a positioned on each side portion of the case 30 in the X direction and a top plate 60b connected between the pair of side plates 60a so as to straddle the case 30 in the X direction. The pressing member 60 is supported by the case 30 via the rotation shaft 62 in each side plate 60a so as to be rotatable, and the pressing portion 61 is formed at the tip of the top plate 60b.

An engaging portion 60c with which the end portion of the spring 64 engages and a contact portion 60d with which the end portion of the spring 65 engages and which contacts the lifting member 631 when the lifting member 631 rises and causes the pressing member 60 to rotate are formed on each side plate 60a. The engaging portion 60c and the contact portion 60d are both formed in a form of a protruding piece in which they protrude in the X direction.

A remaining amount detection sensor 31 is provided on a side portion of the case 30. The remaining amount detection sensor 31 is, for example, an optical sensor. The remaining amount detection sensor 31 is a position detection sensor for detecting the position of the pressing portion 61 by detecting the side plate 60a as well as a sensor for detecting the amount remaining in the container 200 according to the result of detecting the position. Specifically, the detection position of the remaining amount detection sensor 31 is arranged at a position for detecting the side plate 60a when the container 200 deflated due to the remaining amount having decreased is pressed. The press amount at the time of pressing changing according to the degree of deflation of the container 200 is utilized. In the present embodiment, since the pressing portion 61 contacts the container 200, the position of the side plate 60a reflects the amount remaining in the container 200, and thus, the accuracy of the remaining amount detection is high. The detection position of the remaining amount detection sensor 31 is designed to detect the side plate 60a, for example, when the container 200 whose remaining amount is about 100 ml is pressed.

The pressing member 60 can be made of, for example, a metal plate material (steel plate or the like). Although it is thinner than materials such as resin but is strong, it is possible to reduce the height of the slot 3. The rotation shafts 62 of the pressing member 60 are arranged on the outer side of the container 200 in the X direction and are provided at positions at which when the container 200 is full the rotation shafts 62 and the container 200 overlap in the X direction. By these contrivances to reduce the size in the Z direction, even if the pressing member 60 is provided in the slot 3 of each level to provide a mixing function, it is possible to fit many levels of container 200 in a limited space under the housing of the system 100.

Further, the width of the pressing member 60 in the X direction is shorter in the pressing portion 61 than in the vicinity of the rotation shafts 62. This makes it possible to prevent portions other than the pressing portion 61 from contacting the container 200 when the pressing portion 61 presses the tank and thus prevent the container 200 from being damaged.

By configuring the width of the pressing member 60 in the X direction to be shorter in the pressing portion 61 than in the vicinity of the rotation shafts 62, there are the following advantages. As described above, the container 200 is provided with the gusset portions 202a on the side surfaces. The gusset portions 202a include welded portions between the flexible members and are more rigid than other portions. In order to fold the gusset portions 202a in and deflate the container 200 in response to a decrease in the amount remaining in the container 200, a suitable pressing force is necessary. In a state in which the amount remaining in the container 200 is large, the gusset portions 202a spread in the up-down direction, and there are cases where the gusset portions 202a expand outward rather than being inward. A suitable pressing force is necessary to collapse the gusset portions 202a.

By arranging the pressing portion 61 farther inward in the X direction than the gusset portions 202a, it is possible to efficiently press and deform the container 200 for mixing. That is, the pressing portion 61 is arranged so as to press the container 200 on the center side relative to the gusset portion 202a. The height of the gusset portion 202a is, for example, about 20 mm on both side surfaces, and by the pressing portion 61 being farther inward than the gusset portions 202a of both side surfaces, it is less susceptible to the counterforce of the gusset portions 202a and thus, it is possible to efficiently press the container 200. The pressing is performed efficiently when the width of the pressing portion 61 in the X direction is designed to be a size that fits within, for example, 10 mm or more, inward than the gusset portions 202a. This is because the effect of the counterforce of the gusset portions 202a is further decreased by the pressing portion 61 being away from the gusset portions 202a in the X direction. The width of the pressing portion 61 in the X direction may be designed to be at least 1 mm away from the gusset portion 202a, and for example, may be designed to be 5 mm or 10 mm away.

As a form for minimizing the width of the pressing portion 61 in the X direction, the pressing portion 61 may take a shape that contacts the container 200 at a point, for example. However, in the case where the container 200 takes a form in which it is long in the Y direction as in the present embodiment, when a shape in which the pressing portion 61 contacts the container 200 at a point is assumed, the flowability of the liquid in the container 200 may decrease. Specifically, when the width of the pressing portion 61 in the X direction is too small, the flow of the liquid corresponding to the press by the container 200 being pressed is dispersed outward in the X direction, and thus, the amount of flow of the liquid in the Y-direction decreases accordingly.

Accordingly, for example, by configuring the width of the pressing portion 61 in the X direction to be a width that is one-third or more of the width of the bag 202 of the container 200 in the X direction, it is possible to improve the flowability of the liquid in the Y direction in the bag 202 at the time of pressing. For example, if the width of the bag 202 in the X direction is 180 mm, by configuring the width of the pressing portion 61 in the X direction to be 60 mm or more, it is possible to improve the flowability of the liquid in the Y direction in the bag 202 at the time of pressing.

Summarizing the above, if the width in the X direction is a width of 180 mm regarding the bag 202 and the gusset portions 202a whose heights are 20 mm are included regarding the gusset portions 202a, the width of the pressing portion 61 in the X direction is suitably between 60 mm to 120 mm and, in particular, may be 90 mm.

### (Mixing Operation)

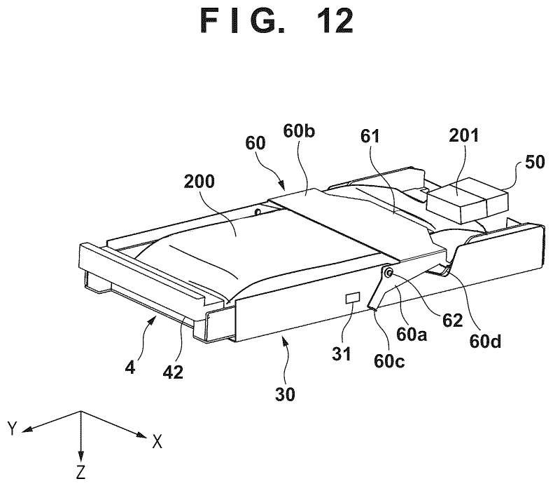

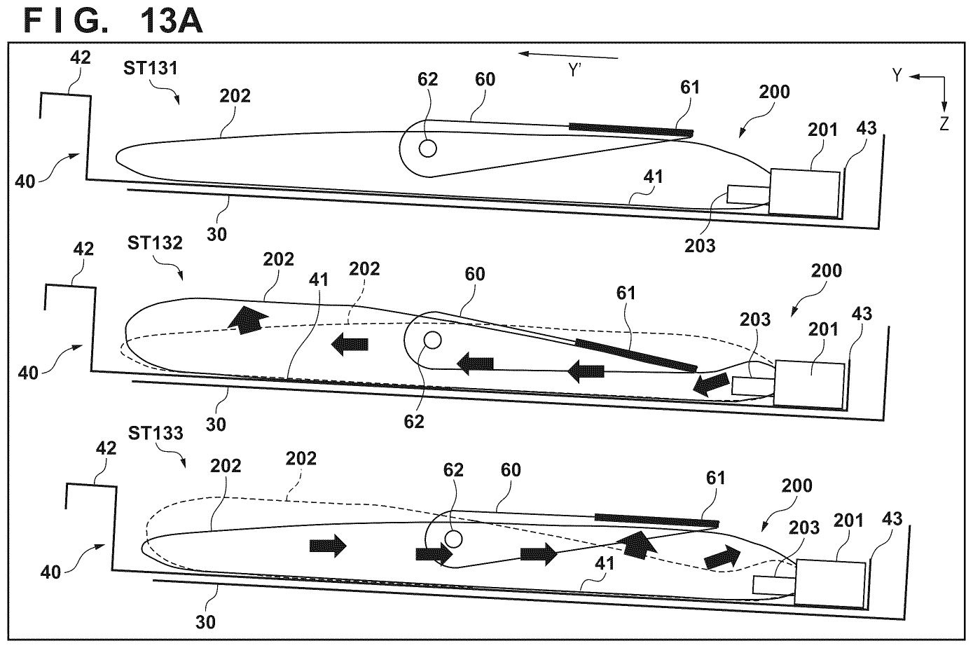

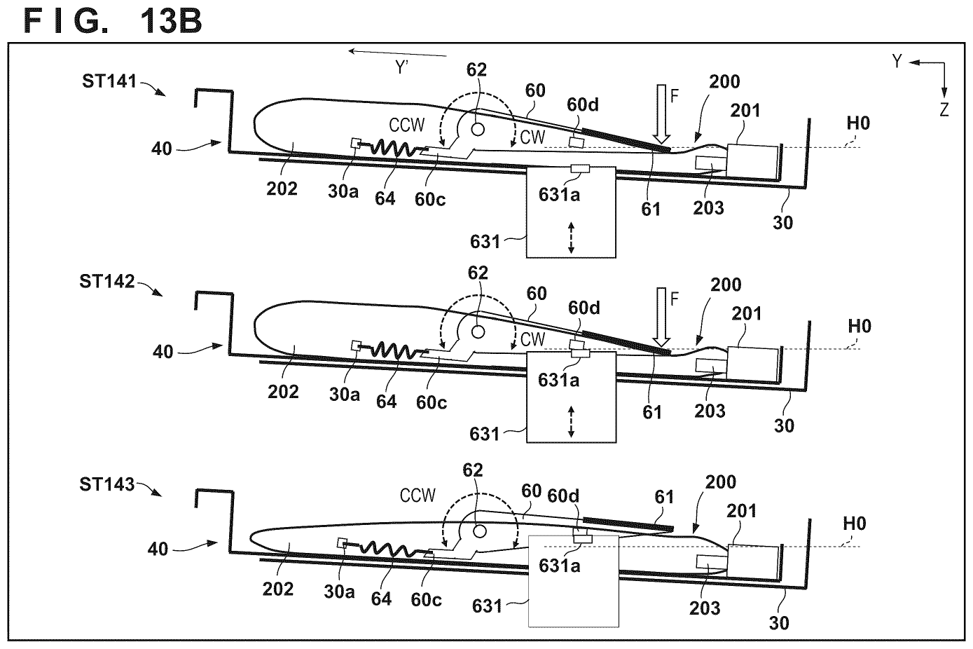

The mixing operation of the liquid in the container 200 by the pressing portion 61 pressing the container 200 will be described with reference to FIG. 13A. FIG. 13A is an explanatory view of the mixing operation. As illustrated in FIG. 7, the mounting orientation of the support unit 4 is inclined in the present embodiment. In FIG. 13A, a direction that is parallel to a direction of the inclination angle of the mounting orientation is set to be a Y′ direction. In the following description, the outlet member 201 side of the container 200 may be referred to as a −Y′ direction, and the side opposite thereto may be referred to as a +Y′ direction. The arrows of FIG. 13A represent liquid flow directions generated inside the bag 202 of the container 200.

In the case of the present embodiment, the mixing operation consists of a pressing operation and a pressing reduced operation. The pressing portion 61 is arranged so as to face the placement surface 41 of the support unit 4. The pressing portion 61 is moved back and forth between the pressing reduced position and the pressing position. This causes the bag 202 to deform, and the liquid inside is caused to flow and is thus mixed.

A state ST131 of FIG. 13A indicates a state in which the pressing portion 61 (and the pressing member 60) is in the pressing reduced position. In the case of the present embodiment, in the pressing reduced position, the pressing portion 61 is separated from the placement surface 41 and is positioned at a height at which it does not contact the bag 202 and thus is not pressing the bag 202. Therefore, the pressing reduced position can also be referred to as a pressing released position.

The moving mechanism 63 is driven from the state ST131 of FIG. 13A, and the pressing operation is performed as indicated in a state ST132 of FIG. 13A. In the pressing operation, the pressing portion 61 is moved by the rotation of the pressing member 60 to a position closer to the placement surface 41 than the pressing reduced position and presses the bag 202 to the placement surface 41 side. This deforms the bag 202, and the liquid inside flows and is thus mixed.

In the present embodiment, the container 200 is mounted in the slot 3 in an orientation in which the outlet member 201 is inclined downward in the Z direction. Therefore, at the stage of the state ST131 of FIG. 13A, the liquid in the container 200 tends to be distributed unevenly to the outlet member 201 side due to its own weight, and the bag 202 expands on the outlet member 201 side than in the central portion in the Y′ direction. The pressing portion 61 is designed to press the end portion 43 side on which the outlet member 201 is provided between the end portions 42 and 43 of the container 200. The pressing portion 61 presses the expanded portion of the bag 202 or a portion close thereto, and thus, it is possible to promote the flow of the liquid in the bag 202. The portion pressed by the pressing portion 61 may be the most expanded portion of the bag 202.

If the inclination angle is too large, the imbalance of the liquid in the container 200 increases, and a counterforce from the weight of the collected liquid increases. As a result, the load applied to the pressing member 60 increases when pressing with the pressing member 60. Therefore, as described above, the inclination angle is set to less than 45 degrees, and in particular, preferably 10 degrees or less. The inclination angle of the present embodiment is set to 3 degrees. These inclination angles may be set according to the amount of liquid that can be stored in the container 200. For example, when the amount of liquid is small, the inclination angle may be set larger than when the amount is large.

When, the liquid flows to the opposite side by the outlet member 201 side of bag 202 being pressed by the pressing portion 61, mixing can be performed efficiently. The rotation shaft 62 of the pressing member 60 is positioned on the side opposite to the outlet member 201 when viewed from the pressing portion 61 in the Y′ direction of the container 200. In the pressing operation, the direction of rotation of the pressing member 60 is a clockwise direction in the state ST132 of FIG. 13A. That is, the pressing member 60 rotates in the clockwise direction with the rotation shaft 62 as the center of rotation. When the rotation direction is thus set, a vector directed in the +Y′ direction is generated, and it becomes easy to cause the liquid to flow in the +Y′ direction. That is, it becomes easy for the liquid to flow to the side opposite to the outlet member 201 side of bag 202.

As described above, in the present embodiment, the pressing portion 61 is designed to press the end portion 43 side on which the outlet member 201 is provided between the end portions 42 and 43 of the container 200. The vicinity of the intake port 203 of the container 200 is pressed on the bag 202, and the mixing of the liquid in the vicinity thereof is particularly promoted. At the time of printing, the liquid in the container 200 flows out from a region near the intake port 203 into the tube 51. By performing mixing by pressing the vicinity of the intake port 203, it is possible to feed a liquid with a more uniform density into the tube 51.

The moving mechanism 63 is driven from the state ST132 of FIG. 13A, and the pressing reduced operation is performed as indicated in a state ST133 of FIG. 13A. In the pressing reduced operation, the pressing portion 61 returns to the pressing reduced position from the pressing position by the rotation of the pressing member 60. That is, the pressing member 60 rotates in the counterclockwise direction in the state ST133 of FIG. 13, with the rotation shaft 62 as the center of rotation. That is, when transitioning from the state ST132 of FIG. 13 to the state ST133 of FIG. 13, the pressing member 60 reverses the direction of rotation. The liquid in the bag 202 flows by the release of pressing by the pressing member 60, and the bag 202 returns to the original shape. Thereafter, it is possible to perform the pressing operation again.

The liquid in the bag 202 is mixed by repeating the pressing operation and the pressing reduced operation. That is, when the pressing portion 61 is in the pressing position as in the state ST132 of FIG. 13A, the vicinity of the pressing portion 61 of the container 200 is recessed, the liquid flows in the +Y′ direction, and the side opposite to the outlet member 201 of the container 200 expands. Then, when the pressure is reduced as in the state ST133 of FIG. 13A, the ink that flowed due to the pressure flows in the −Y′ direction due to its own weight. By repeating the pressing operation and the pressing reduced operation, the liquid moves back and forth in the Y′ direction in the bag 202 and is thus mixed. The flow of the liquid caused by the pressing reduced operation utilizes the weight thereof. By utilizing the weight thereof, a mechanism required for mixing the liquid can be made to have a simple configuration.

During the series of pressing operations of FIG. 13A, the channel valve 52 may be in either the open state or the closed state. That is, in the channel in which liquid is supplied to the discharge head 108, control is performed such that the channel valve 52 is in the open state, and in the channel in which liquid is not supplied to the discharge head 108, the channel valve 52 is in the closed state. Therefore, during the series of pressing operations of FIG. 13A, it is possible to perform the printing operation by the discharge head 108 in parallel.

The operation of the pressing member 60 and the moving mechanism 63 in the series of pressing operations illustrated in FIG. 13A will be described with reference to FIG. 13B. The pressing member 60 rotates about the rotation shaft 62, and the pressing portion 61 enters a pressing state with rotation in the CW direction and a pressing reduced state with rotation in the CCW direction.

The function of the spring 64 will be described. The engaging portion 60c is formed on the pressing member 60, and an engaging portion 30a is formed on the case 30. The spring 64 is provided between these engaging portions 60c and 30a. The pressing member 60 is biased to rotate in the CW direction by the tensile force of the spring 64, and the pressing portion 61 enters the pressing state.

A contact portion 631a is provided in the lifting member 631. As indicated in the state ST142 of FIG. 13B, when the lifting member 631 moves upward, the contact portion 631a of the lifting member 631 comes into contact with the contact portion 60d of the pressing member 60. This position is assumed as a contact reference height HO. As indicated in a state ST143 of FIG. 13B, by the lifting member 631 moving further upward, the pressing member 60 rotates in the CCW direction about the rotation shaft 62, and the pressing portion 61 enters a pressing reduced state.

Conversely, when the lifting member 631 moves downward, the contact portion 631a of the lifting member 631 separates from the contact portion 60d of the pressing member 60. The pressing member 60 is biased to rotate in the CW direction by the tensile force of the spring 64, and the pressing portion 61 enters the pressing state again. The pressing member 60 thus rotates between the pressing position and the pressing reduced position by the lifting motion of the lifting member 631.

In a state ST141 of FIG. 13B, the rotation of the pressing member 60 stops at a position in which a pressing load F from the pressing portion 61 due to the spring 64 is balanced with the counterforce of the container 200. Therefore, as the remaining amount of liquid in the container 200 decreases, the position (pressing position) in which the forces are balanced lowers accordingly. Since the pressing height of the pressing member 60 thus changes according to the remaining amount of liquid in the container 200, it is possible to press and mix the container 200 in a manner that follows the remaining amount of liquid in the container 200.

Next, when repeating the mixing operation, it is possible to adjust the liquid mixing performance according to the frequency thereof. At the time of the pressing reduced operation, the liquid in the bag 202 flows at a slight delay from the rotation of the pressing member 60. The higher the liquidity of the liquid at the time of the pressing reduced operation, the higher the mixing effect. Further, when the pressing operation is performed after the liquid has flowed sufficiently, the amount of liquid stored in the bag 202 increases in the vicinity of the pressing portion 61 and the bag 202 expands, and thus, by pressing there, the mixing performance further increases. The frequency of the mixing operation is a frequency lower than, for example, several Hz, in particular, a frequency lower than 1 Hz. If the frequency of the mixing operation is too low, the total time of the mixing operation increases, and the amount of power consumed by the motor 635 may increase. Therefore, the frequency of the mixing operation, for example, may be in a range of 0.5 to 0.7 Hz, in particular 0.6 Hz. That is, a configuration in which the series of operations of FIG. 13A is performed at a cycle of about 1.6 to 1.7 seconds, for example, is preferable.

Further, when the container 200 deflates due to a decrease in the remaining amount, the ink flows to the −Y′ side due to its own weight and the upper side (+Y′ side) of the inclined container 200 decreases in the amount stored in that portion. Conversely, the liquid accumulates on the lower side (−Y′ side). In this state, the flow distance of the liquid in the +Y′ direction at the time of the pressing operation is shortened, and thus, the time it takes for the liquid to return at the time of the pressing reduced operation is short. Therefore, the period of the mixing operation may be shortened according to a decrease in the amount remaining in the container 200.

In the mixing operation, the pressing operation and the pressing reduced operation may be repeated with temporal intervals between the pressing reduced operation and the next pressing operation. After the pressing reduced operation, it is possible to take a long time for the liquid to flow in the bag 202 until the next pressing operation is started, and thus, it is possible to further promote the flow of liquid by its own weight. For example, by stopping for 0.1 to 0.5 seconds in the state ST132 of FIG. 13A and the state ST133 of FIG. 13A, it is possible to promote liquid flow and improve mixing efficiency. The stopping time may be appropriately set according to the amount of liquid that can be stored in the bag 202.

There are several methods of adjusting the frequency of mixing operation. First is a method of utilizing a dwell angle which is a range in which the cam follower 637 that contacts the inner cam surface 633e and the outer cam surface 633d does not displace even when the cam 633 rotates. For example, the dwell angle at a position in which the cam follower 637 is at the highest point is set to 40 degrees, and the dwell angle at the lowest point is also set to 40 degrees. In particular, by reserving 40 degrees of dwell angle at the highest point, it is possible to maintain the pressing reduced position.

Further, an allocation angle, which is an angle range for raising or lowering the cam follower 637, may be large, such as, 140 degrees each. This reduces the load at the time of rotation of the cam 633 an also slowly transitions the connected pressing member 60 from the pressing state to the pressing reduced position and thus has an effect of ensuring the time for the ink to move to the vicinity of the pressing portion 61 in the meantime. Thus, the ink is sufficiently moved at the time of releasing the pressure, and thus, the mixing effect increases.

Further, another method is a method of pausing the motor 635 in the pressing reduced position. If the time corresponding to the above dwell angle of 40 degrees is implemented by stopping the motor, the dwell angle can be decreased, and thus, the allocation angle can be increased, and thereby, it is possible to reduce the load at the time of cam rotation.

A timing at which to perform the mixing operation may be any time, such as during an operation for supplying liquid to the liquid discharge apparatus 101, during a recovery operation for the discharge head 108 in the liquid discharge apparatus 101, and during a printing operation standby. The timing of the mixing operation is basically not influenced by the operation of the liquid supply apparatus 1 or the liquid discharge apparatus 101.

A mixing period in which the mixing operation is repeated may be based on time or the number of operations. For example, several 10 minutes may be set as one cycle, and the mixing operation may be repeated for only one cycle per day. Further, for example, several 10 times may be set as one cycle, and the mixing operation may be repeated for only one cycle per day. The necessary mixing period and the execution timing may be set in consideration of the velocity at which the coloring material settles in the liquid.

Referring to FIG. 7, as described above, the containers 200 and the support units 4 are inclined with respect to the horizontal plane in a state in which they are mounted in the slot 3. In terms of the liquid mixing effect, it is advantageous if the inclination angle is less than 45 degrees and more advantageous if, for example, 20 degrees or less, and particularly, 10 degrees or less. In the example of FIG. 7, 3 degrees is assumed as the inclination angle.

It is possible to perform mixing by pressing even if the inclination angle approaches 90 degrees, but the weight of the ink acts in a direction that resists the flow of liquid by pressing. Therefore, a stronger pressing force is required for the liquid to flow sufficiently. When the inclination angle is set to be less than 45 degrees, a vector of flow of liquid towards the −Y direction due to the weight of the liquid becomes relatively small. Regarding the amount of expansion in a portion of the bag 202 on the −Y side at the time of the pressing operation, if the inclination angle is set to be 10 degree is or less, a larger amount of expansion will be obtained with a small pressing force. If the amount of expansion of the bag 202 at the time of pressing is large, the amount of flow of the liquid inside will be large. That is, the efficiency by pressing is good.

In the present embodiment, the pressing portion 61 is positioned at a height at which it does not contact the bag 202 in the pressing reduced position, but the pressing portion 61 may contact the bag 202 and may be in a position in which it presses the bag 202 less than in the pressing position. Thus, if it is in a micro-pressing state in the pressing reduced position, it is possible to keep the upper limit position of the pressing member 60 in the Z direction low, and thus, it is possible to reduce the dimension of the liquid supply apparatus 1 in the Z direction.

Further, in the present embodiment, the pressing member 60 is provided in the case 30 of the slot 3, but a configuration may be taken in which the pressing member 60 is provided in the support unit 4. In this case, a configuration that allows driving transmission between the moving mechanism 63 and the pressing member 60 when the support unit 4 is mounted to the slot 3 need only be added.

Further, in the present embodiment, a configuration in which the container 200 is pressed by the pressing portion 61 has been described; however, for example, a configuration in which the container 200 is deformed by repeating compressed air pressing and stopping may be taken. Further, the container 200 may be deformed by the pressurizing and depressurizing the space around the container 200.

### (Display Apparatus)

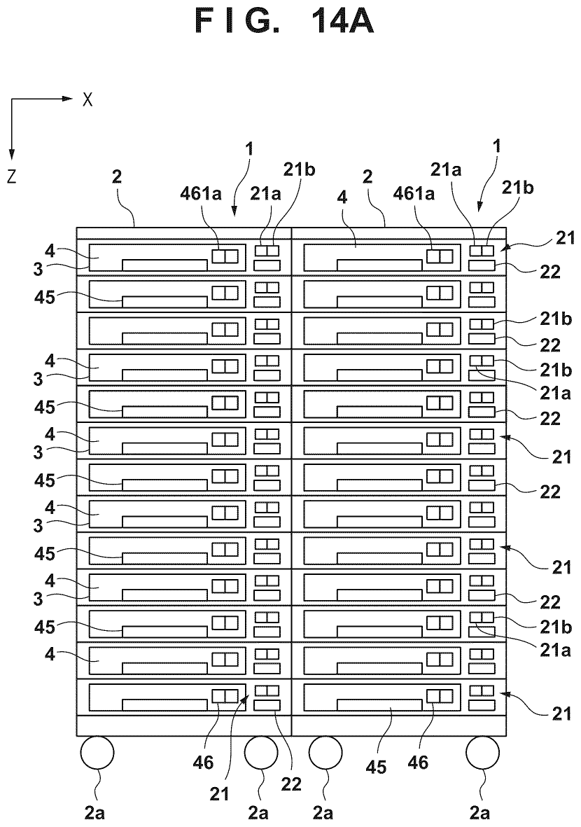

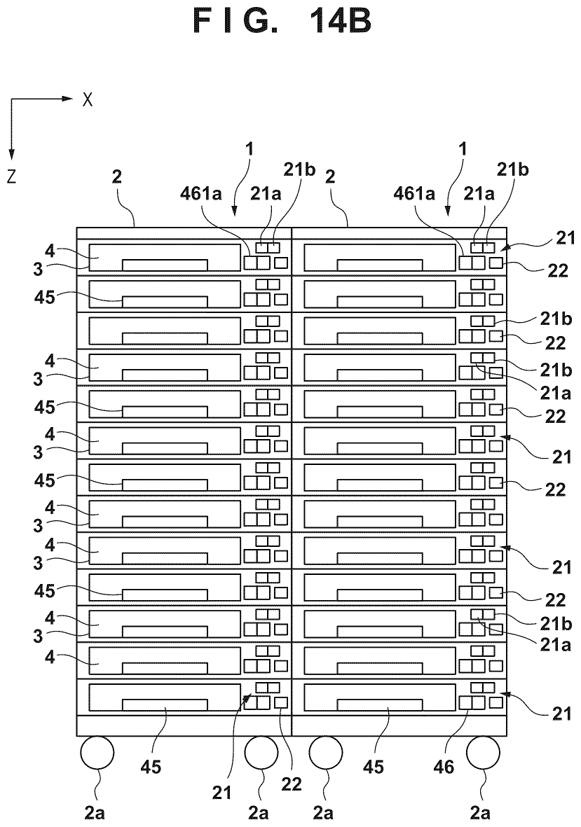

A display apparatus provided in the liquid supply apparatus 1 will be described with reference to FIGS. 3 and 14A. FIG. 14A is a front view of the liquid supply apparatus 1. In the body 2, a status display unit 21 and a type display unit 22 are provided for each slot 3. The status display unit 21 and the type display unit 22 are arranged on the outer wall portion 2b and adjacent to the opening of the corresponding slot 3. In the present embodiment, the status display unit 21 is an electronic display and performs notification related to the status of the container 200 mounted in the corresponding slot 3. Specifically, the status display unit 21 is configured by two light emitting elements 21a and 21b. The light emitting elements 21a and 21b each are, for example, an LED whose light color is different. The light emitting elements 21a and 21b each are independently driven, and driving modes such as on, flashing, and off can be switched. The state of the corresponding container 200 can be communicated to the user, using a combination (e.g., on and flashing, on and off, flashing and on, etc.) of driving modes.

The state of the container 200 to be communicated to the user is, for example, the remaining amount of liquid of the container 200. An amount of consumption (amount of discharge) of liquid stored in the container 200 can be estimated from the discharge control amount of the discharge head 108. The remaining amount of liquid of the container 200 is estimated from the estimated consumption amount, and when the remaining amount is less than a threshold, one of the two light emitting elements 21a and 21b is caused to flash. This makes it possible to notify the user of a timing for replacing the container 200, and thus, it is possible to prompt the preparation of the container 200 with a full liquid.

The type display unit 22 displays information on the type of liquid assigned to the corresponding slot 3. The type display unit 22 may be an electronic display but in the case of the present embodiment is a non-electronic display and is a sheet (color label) or a plate material, such as plastic or paper colored in the color of liquid. With the type display unit 22, the user can visually understand the container 200 storing which type of liquid is to be mounted in which slot 3.

In the present embodiment, a pair of the status display unit 21 and the type display unit 22 corresponding to a respective slot 3 are arranged collectively on the X direction side with respect to the slot 3, and particularly, are arranged so as to align in the Z direction. By thus arranging the status display unit 21 and the type display unit 22 so as to overlap in the X direction, the width of the body 2 in the X direction can be reduced. Further, in the present embodiment, a pair of the status display unit 21 and the type display unit 22 are arranged on the +X direction side of the slot 3, and as described above, the moving mechanism 63 is arranged on the side portion of the body 2 in the +X direction. The moving mechanism 63 is at a position behind the space in which the pair of the status display unit 21 and the type display unit 22 are arranged. By having such components concentrate on the side portion of the body 2 in the +X direction and each overlap in the X direction, the side portion of the body 2 in the −X direction can be configured to be thin. It is possible to achieve downsizing of the liquid supply apparatus 1 as a whole.

Furthermore, the operation portion 461a of the lock mechanism 46 is arranged at the end portion of the support unit 4 in the +X direction. The sensor 38 for detecting the position of the sliding member 461 is positioned behind the space in which the pair of the status display unit 21 and the type display unit 22 are arranged. By providing the lock mechanism 46 itself on the support unit 4 and arranging the sensor 38, which is relatively small in size, on the +X direction side outside the support unit 4, it is possible to downsize the liquid supply apparatus 1. Further, by aggregating the components related to operations by the user and display to the user on the +X-direction end portion of the front surface of the body 2, usability can be improved.

As an example of the arrangement of the operation portion 461a, an example of FIG. 14B can also be employed. The difference between FIG. 14A and FIG. 14B is mainly the position of the operation portion 461a, and the operation portion 461a is arranged on the body 2 rather than in the support unit 4. That is, in a state in which the support unit 4 is removed from the slot 3, the operation portion 461a remains on the body 2 side. By doing so, it is possible to simplify the configuration of the support unit 4.

### <Control Circuit>

A configuration of a control circuit of the system 100 will be described with reference to FIG. 15. FIG. 15 is a block diagram of the control circuit of the system 100. A main control unit 317 controls the entire system 100 in response to instructions from a host computer 918 and the operation panel 110. A control unit 915 controls the liquid discharge apparatus 101 based on instructions of the main control unit 317, and a control unit 916 controls the liquid supply apparatus 1 based on instructions of the main control unit 317. The main control unit 917 and the control units 915 and 916 include, for example, at least one processor, at least one storage device, and at least one input/output interface. The storage device is, for example, a semiconductor memory, such as a RAM and a ROM. The input/output interface performs input/output of signals between the processor and external devices (e.g., sensors and motors).

A discharge control unit 901 performs control of the discharge head 108, in particular control for discharging of a liquid. A conveyance motor 902 drives the conveyance unit 106. A carriage motor 903 is a driving source of the moving mechanism of a carriage (not illustrated). A winding motor 904 is a driving source of the winding unit 105. A cutter motor 905 is a driving source of a cutter (not illustrated) for cutting the printing medium M on which an image has been printed. A recovery motor 906 is a driving source of the recovery unit 109. These are controlled by the control unit 915.

A clock unit 909 is a counter for outputting a result of counting elapsed time to the control unit 916. When the mixing period is managed in time, it is possible to use the count result of the clock unit 909. Further, it is also possible to determine the mixing timing by using the count result of the clock unit 909.

The sensor 31 and the sensor 38 detect the amount remaining in the container 200 and the position of the sliding member 461, respectively, as described above, and these detection results are obtained by the control unit 916. The motor 635 drives the moving mechanism 63, and a channel valve switching motor 913 switches the closing and releasing of the channel valve 52. A liquid supply motor 911 is a driving source for sending liquid from the container 200 to the liquid discharge apparatus 101, and the liquid is sucked from the container 200 by the liquid supply motor 911 being driven while the channel valve 52 is in the open state and is supplied to the liquid discharge apparatus 101. These motors are controlled by the control unit 916. The driving of the status display unit 21 is also controlled by the control unit 916.

### <Example of Processing of Control Circuit>

An example of processing to be executed by the control unit 916 regarding the mixing operation will be described. FIG. 16A is a flowchart thereof. In step S1, it is determined whether a mixing start condition (pressing start condition) is satisfied. When the mixing start condition is satisfied, the processing proceeds to step S2. The mixing start condition is, for example, an arrival of a predetermined time of the day, when an elapsed time from the end of the previous mixing operation has reached a predetermined length of time, or when the user instructs mixing via the operation panel 110, or the like. At the time of initial installation of the liquid supply apparatus 1 or when the container 200 has been replaced, there are cases where the coloring material has settled, and thus, it may be made easy for the start condition to be satisfied. For example, if the mixing operation is to be performed only one cycle per day, two cycles may be performed per day.

In step S2, the mixing operation is started. Specifically, the moving mechanism 63 is driven by driving the motor 635 to rotate the pressing member 60. The pressing portion 61 moves back and forth between the pressing reduced position and the pressing position, and the pressing operation and the pressing reduced operation are thus repeated.

In step S3, it is determined whether an end condition is satisfied. When the end condition is satisfied, the processing proceeds to step S4. The end condition is, for example, elapsing of a predetermined length of time, when the number of operations of the mixing operation has reached a predetermined number of times, when the amount of rotation of the motor 635 has reached a predetermined amount of rotation, or when the user instructs the end of mixing via the operation panel 110 or the like. At the time of initial installation of the liquid supply apparatus 1 or when the container 200 has been replaced, it may be made difficult for the end condition to be satisfied. For example, if the end condition is the elapsation of a predetermined length of time, the predetermined length of time may be increased. In the case it is set to when the number of operations of the mixing operation has reached a predetermined number of times, the predetermined number of times may be increased.

In step S4, the mixing operation is ended. Specifically, the driving of the motor 635 is stopped to stop the moving mechanism 63. The motor 635 may be stopped when the pressing portion 61 (pressing member 60) is in the pressing reduced position, and in this case, even if the support unit 4 is inserted or removed thereafter, the pressing member 60 will not interfere. With the above, the processing ends.

FIG. 16B illustrates an example of processing related to unlocking of the lock mechanism 46. In step S11, a detection result of the sensor 38 of each slot 3 is obtained, and it is determined whether there is a support unit 4 for which the lock mechanism 46 has been unlocked. If there is a support unit 4 for which the lock mechanism 46 has been unlocked, the processing proceeds to step S12. In step S12, the channel valve switching motor 912 of the channel valve 52 corresponding to the support unit 4 that has been unlocked is driven, and the channel valve 52 enters a closed state. In step S13, regardless of whether the mixing operation is in progress, the motor 635 is driven and the pressing portion 61 (pressing member 60) is moved to the pressing reduced position. With the above, the processing ends. Even if the support unit 4 is removed from the slot 3, it is possible to prevent air from entering the tube 51 and also prevent the pressing member 60 from interfering with the insertion and removal of the support unit 4.

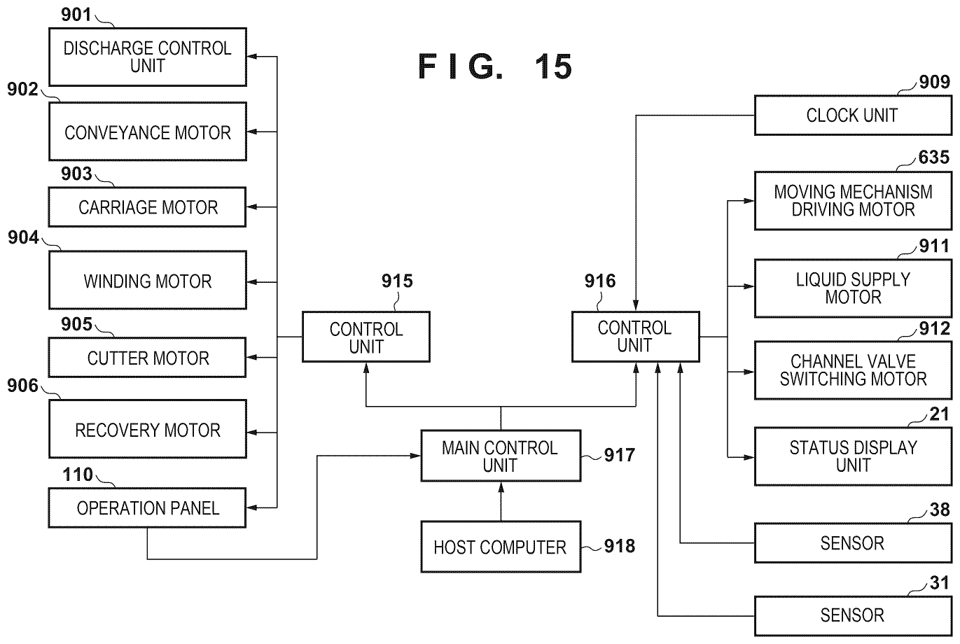

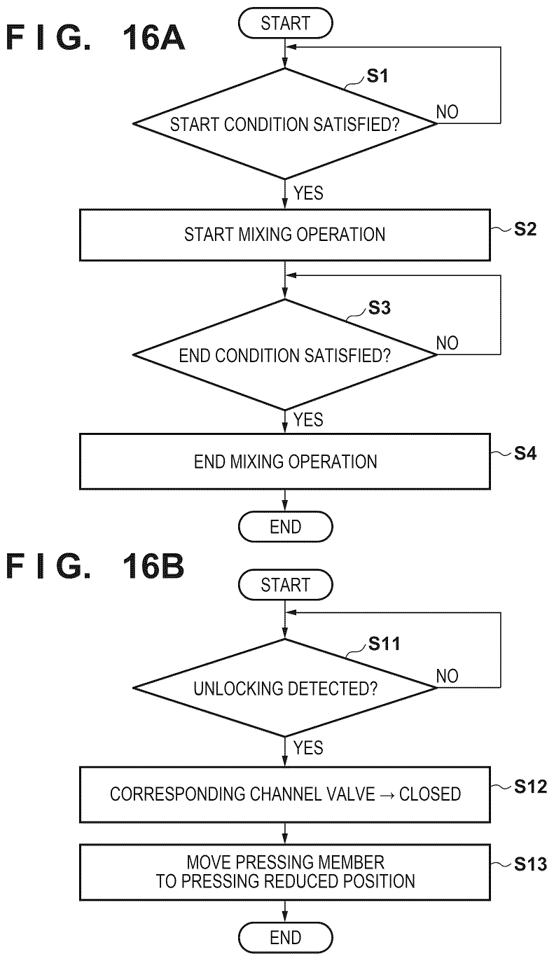

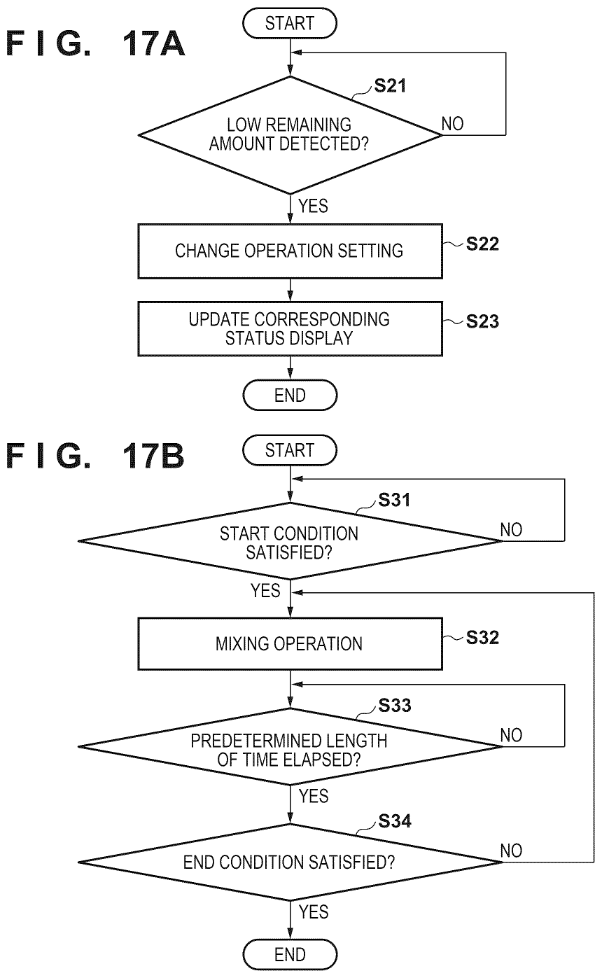

FIG. 17A illustrates an example of changing the operation setting of the mixing operation according to a change condition being satisfied, in particular illustrates an example of processing based on a detection result of the remaining amount of liquid of the container 200 as the change condition. This processing example can be performed in parallel during the mixing operation.

In step S21, the detection result of the sensor 31 of each slot 3 is obtained, and it is determined whether there is a container 200 whose remaining amount is low (container 200 for which the side plate 60a of the pressing member 60 has been detected by the sensor 31). If there is a container 200 whose remaining amount is low, the processing proceeds to step S22.

In step S22, the operation setting for the mixing operation of the next cycle is changed. For example, if the mixing period is set based on time, the time is decreased. If the mixing period is set based on the number of operations, the number of operation is decreased. Further, for example, the period of the mixing operation is decreased. Further, for example, an interval between the pressing reduced operation and the next pressing operation is decreased.

Further, for example, the mixing start condition for which determination is performed in step S1 (pressing start condition) is changed so that the frequency is reduced. Specifically, if one cycle of mixing operation had been performed at a frequency of once a day, one cycle of mixing operation may be performed at a frequency of twice a day. In the present embodiment, since the moving mechanism 63 is shared by all the pressing members 60, the change to the operation setting extends to the mixing operation of all the containers 200. If the remaining amount of some of the containers 200 is reduced, the change of the operation setting also affects the mixing operation of the containers 200 that are substantially full; however, it is assumed that the operation setting is performed with priority to the container 200 whose remaining amount has decreased.

In step S23, the display of the status display unit 21 corresponding to the container 200 whose remaining amount is low is updated to notify the user of a decrease in remaining amount. With the above, the processing ends.

### Second Embodiment

In the first embodiment, the moving mechanism 63 is shared by all the pressing members 60; however, while sharing the moving mechanism 63, a mechanism for switching transmission/interruption of the driving force for each pressing member 60 may be provided for each pressing member 60 to individually rotate each pressing member 60. Alternatively, an independent moving mechanism may be provided for each pressing member 60 to independently rotate each pressing member 60. Further, the motion of the pressing member 60 in the mixing operation may be a translational motion rather than a rotational motion.

### Third Embodiment

As an example of processing to be executed by the control unit 916 regarding the mixing operation, an example of processing of FIG. 17B may be employed instead of the example of processing of FIG. 16A. The example of the figure is an example of control for pausing the motor 635 with the pressing portion 61 (pressing member 60) in the pressing reduced position.

In step S31, it is determined whether a mixing start condition (pressing start condition) is satisfied. The processing is similar to step S1 of FIG. 16A. When the mixing start condition is satisfied, the processing proceeds to step S32.

In step S32, the mixing operation is performed once. Specifically, the motor 635 is driven from a state in which the pressing portion 61 (pressing member 60) is in the pressing reduced position and the cam 633 is rotated once and then stops. The moving mechanism 63 is driven, and the pressing portion 61 (pressing member 60) moves back and forth between the pressing reduced position and the pressing position once. The amount of rotation of the cam 633 may be managed by detection by a sensor (not illustrated).

In step S33, it is determined whether a predetermined length of time has elapsed. When the predetermined length of time has elapsed, the processing proceeds to step S34. The liquid in the container 200 flows so as to return to the pressing location of the pressing portion 61 due to elapsing of the predetermined length of time.

In step S34, it is determined whether an end condition is satisfied. The processing is similar to step S3 of FIG. 16A. If it is determined that the end condition is not satisfied, the processing returns to step S32. If it is determined that the end condition is satisfied, the processing ends.

### Fourth Embodiment

The pressing portion may be an elastic deforming portion for elastically deforming so as to follow the surface shape of the container 200. For example, the pressing portion may be constituted by a flexible sheet. FIG. 18 is a diagram illustrating an example thereof.

A state ST181 of FIG. 18 indicates a state in which the pressing member 60 is positioned in the pressing reduced position. The pressing member 60 includes a base member 60A and a pressing portion 61A supported by the base member 60A. The base member 60A corresponds to the pressing member 60 of the first embodiment and, in the present embodiment, is configured such that a sheet-like pressing portion 61A is fixed thereto. The pressing portion 61A can be formed of a flexible resin film or the like and constitutes the elastic deforming portion. The pressing portion 61A is in a substantially flat form in a state in which it is positioned in the pressing reduced position.

A state ST182 of FIG. 18 indicates a state in which the pressing portion 61A is positioned in the pressing position. The pressing portion 61A elastically deforms along the shape of the surface of the bag 202 and contacts the bag 202 on a wide surface. Since the pressing portion 61A curves and contacts the bag 202 over the surface, it is possible to press the bag 202 over a wide range, and thus, it is possible to improve the flowability of the liquid even if the amount remaining in the container 200 is low and the bag 202 is deflated. In particular, it is easy for the pressing portion 61A to press into a position deep in the bag 202, the flowability of the liquid improves, and the mixing performance improves.

In the container 200 whose remaining amount is low, the upper and lower surfaces of the bag 202 enters a state in which they are substantially in contact, but some space is created in the vicinity of the intake port 203. Therefore, a liquid pool 202b that is triangular when viewed in cross section may be created. By pressing the liquid pool 202b, it is possible to improve the flowability of the liquid accumulated therein. Therefore, the size of the pressing portion 61A is designed so that the pressing portion 61A reaches the liquid pool 202b. The size of the base member 60A is designed so that the base member 60A does not reach the liquid pool 202b. Regarding the pressing portion 61A, by using a material with a good sliding property such as PET, it is possible to prevent damaging the bag 202 when contacting the bag 202.

### Fifth Embodiment

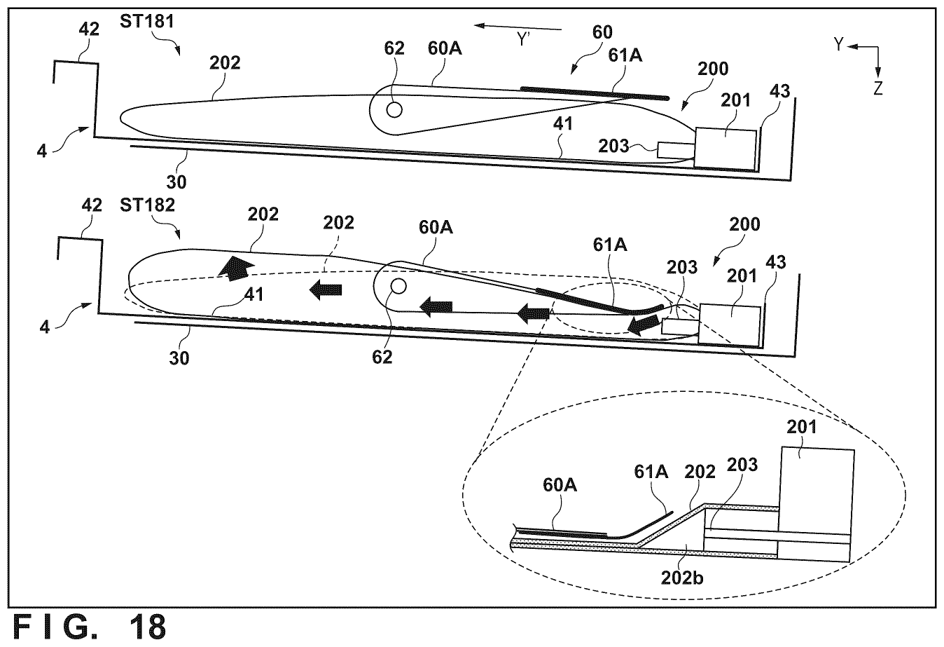

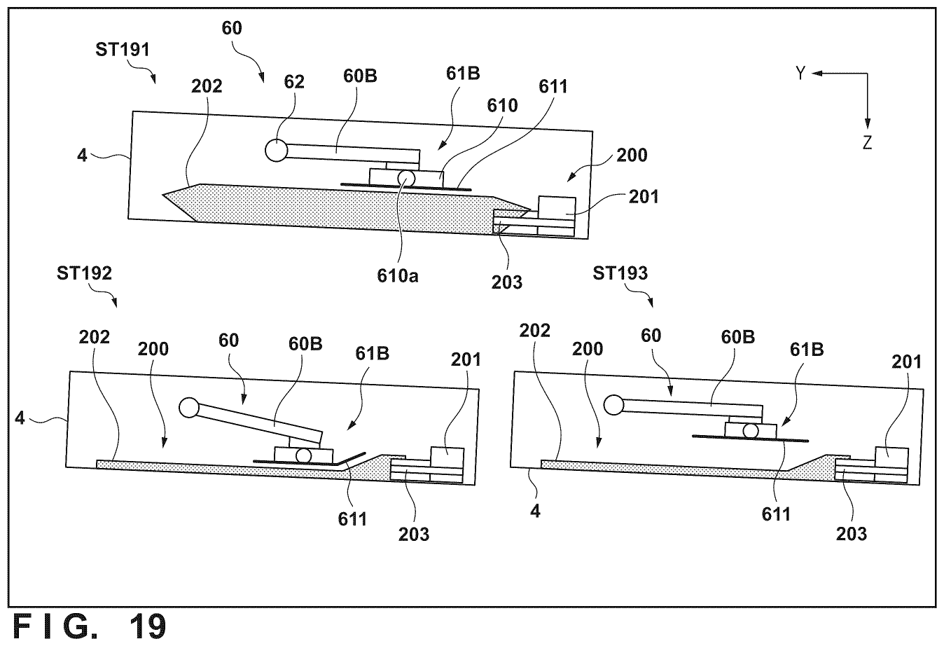

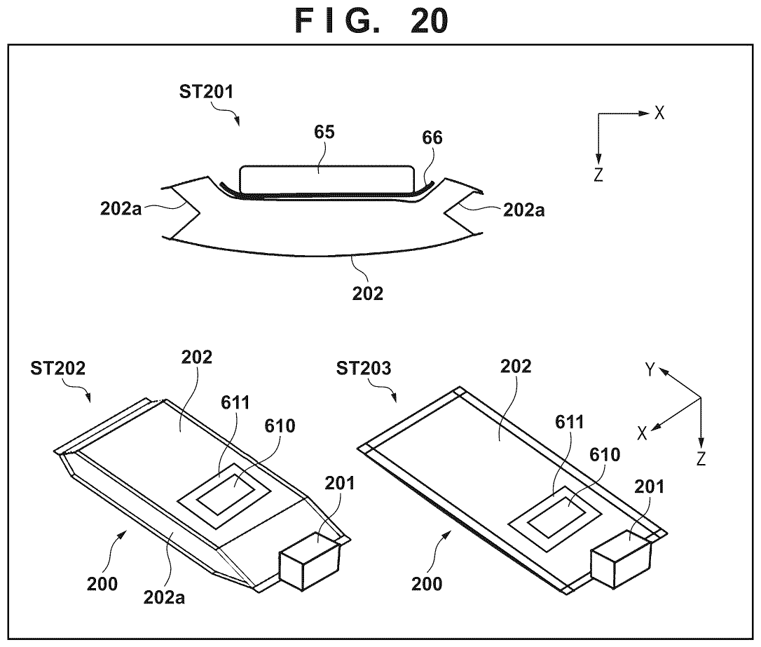

The pressing portion may be movably supported so as to follow the surface shape of the container 200. For example, the pressing portion may be configured to be supported so as to be rotatable. FIG. 19 is a diagram illustrating an example thereof. Further, FIG. 20 is an explanatory view of a pressing location on the container 200, a state ST201 and a state ST202 of FIG. 20 indicate cases where the container 200 is substantially full, and a state ST203 of FIG. 20 indicates a case where the amount remaining the container 200 is small.

A state ST191 of FIG. 19 indicates a state in which the remaining amount of the liquid of the container 200 is substantially full as indicated in the state ST201 of FIG. 20A and the pressing member 60 is positioned in the pressing reduced position. The pressing member 60 includes a base member 60B and a pressing portion 61B supported by the base member 60B. The base member 60B corresponds to the pressing member 60 of the first embodiment and, in the present embodiment, supports the pressing portion 61B via a rotation shaft 610a in the X direction so as to be rotatable. The pressing portion 61B is constituted by a movable member 610 and a flexible sheet 611 supported by the movable member 610. The movable member 610 is supported by the base member 60B via the rotation shaft 610a so as to be rotatable, and the sheet 611 is a member corresponding to the pressing portion 61A of the fourth embodiment.

A state ST192 of FIG. 19 indicates a state in which the pressing portion 61B is positioned in the pressing position in a state in which the remaining amount of liquid of the container 200 is decreased as indicated in the state ST203 of FIG. 20. The sheet 611 of the pressing portion 61B elastically deforms along the shape of the surface of the bag 202 and contacts the bag 202 on a wide surface. Further, since the movable member 610 rotates according to the shape of the surface of the bag 202, a frictional force acting on the bag 202 when the sheet 611 contacts the surface of the bag 202 is reduced, and thus, it is possible to prevent damaging the bag 202.

A state ST193 of FIG. 19C indicates a state in which the pressing portion 61B has returned to the pressing reduced position in a state in which the remaining amount of liquid of the container 200 has decreased. The shape of the sheet 611 is restored.

### Sixth Embodiment

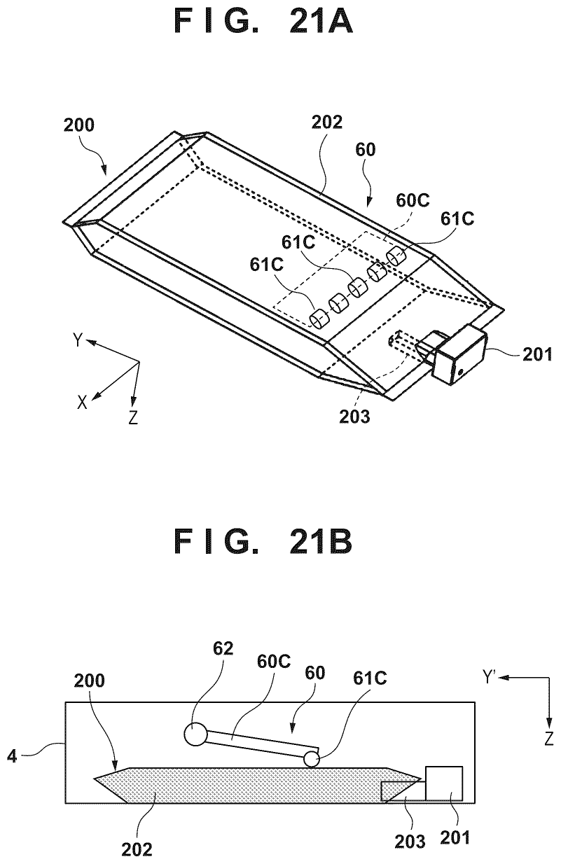

A plurality of pressing portions may be provided. Further, the pressing portions may be constituted by rotatable rotation bodies. FIGS. 21A and 21B are schematic views illustrating an example thereof.

The pressing member 60 includes a base member 60C, and a plurality of pressing portions 61C are roller members rotatably provided at an end portion of the base member 60C. The plurality of pressing portions 61C are arranged so as to be separated from each other in the X direction (width direction of the container 200), and are supported on the base member 60C so as to be rotatable about the rotation axis in the X direction. FIG. 21B illustrates a state in the middle of the pressing operation. Since the frictional force applied to the bag 202 when the pressing portions 61C come into contact with the container 200 can be reduced by the rotating motion of the pressing portions 61C, it is possible to reduce damage to the bag 202. Further, since a plurality of pressing portions 61C are arranged in the X direction, the bag 202 can be uniformly pressed in the X direction, and the flowability of the liquid stored in the bag 202 can be generated throughout the entire interior of the bag 202.

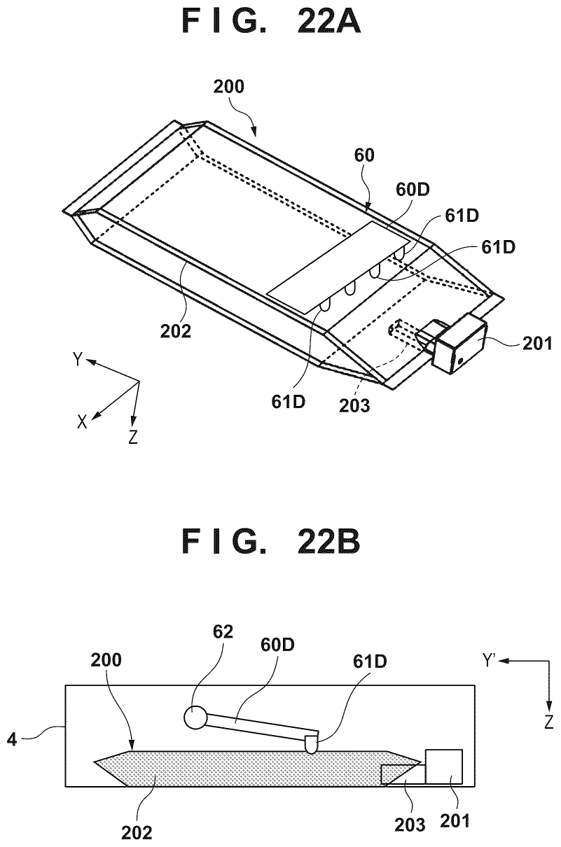

FIGS. 22A and 22B also illustrate an example in which a plurality of pressing portions are provided. The pressing member 60 includes a base member 60D and a plurality of pressing portions 61D fixed to an end portion of the base member 60D. The plurality of pressing portions 61D are arranged so as to be separated from each other in the X direction and are protruding portions protruding toward the container 200, and their tips have a spherical shape. FIG. 22B illustrates a state in the middle of the pressing operation. Since the frictional force applied to the bag 202 when the pressing portions 61D come into contact with the container 200 can be reduced due to the spherical shape of the tips of the pressing portions 61D, it is possible to reduce damage to the bag 202. Further, since a plurality of pressing portions 61D are arranged in the X direction, the bag 202 can be uniformly pressed in the X direction, and the flowability of the liquid stored in the bag 202 can be generated throughout the entire interior of the bag 202.

### Seventh Embodiment

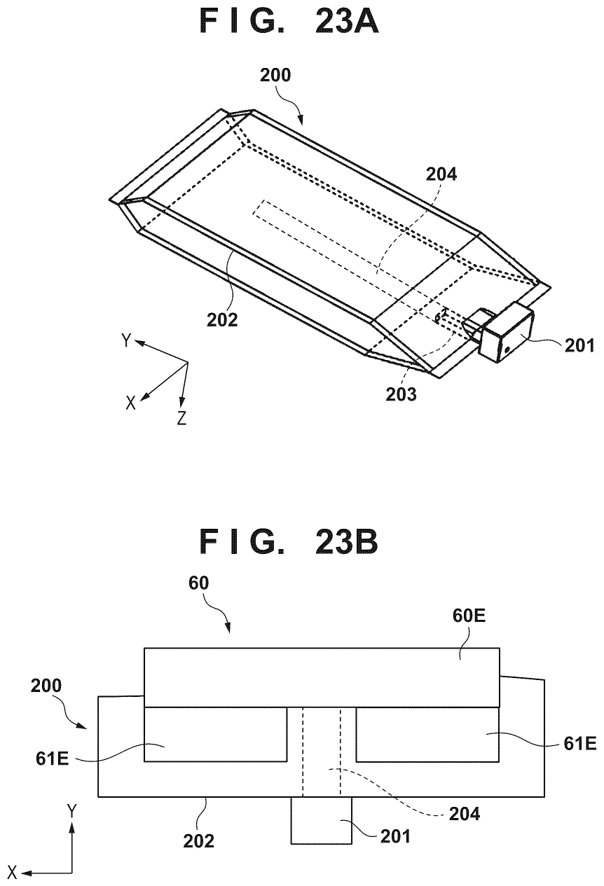

A flexible member that elastically deforms may be incorporated in the bag 202 of the container 200. FIG. 23A illustrates an example thereof. In the example illustrated in the figure, a shaft-shaped flexible member 204 extending in the Y direction is incorporated into the bag 202. The flexible member 204 is arranged in the central portion of the bag 202 in the X direction, one end thereof is fixed to the outlet member 201, and the other end is a free end.

FIG. 23B illustrates an example of a configuration of the pressing member 60 in the case of using the container 200 of FIG. 23A. The pressing member 60 includes a plurality of pressing portions 61E separated in the X direction with respect to the base member 60E. In the present embodiment, two pressing portions 61E are arranged so as to avoid the flexible member 204, and the flexible member 204 passes between the two pressing portions 61E. The pressing portion 61E can adopt the pressing portion 61C or 61D of the sixth embodiment and the like.

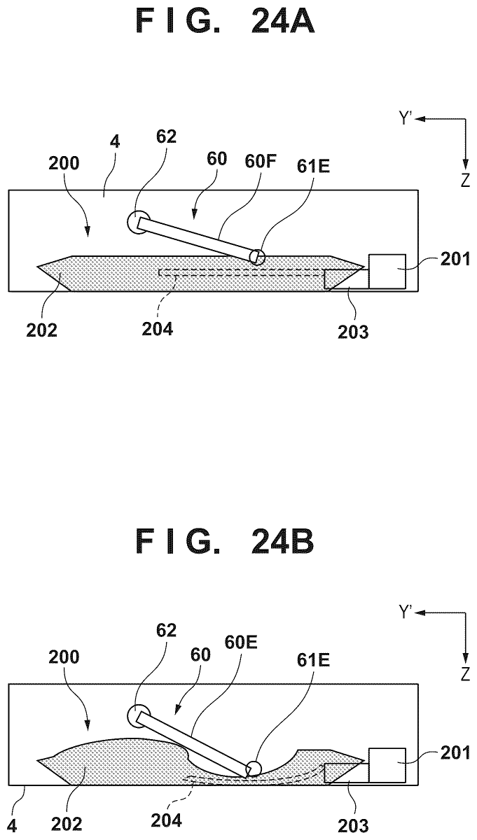

FIGS. 24A and 24B illustrate the pressing operation of the pressing member 60. The base member 60E can press the flexible member 204 and bend it downward. When the pressing is released and the pressing member 60 returns to the pressing reduced position, the bag 202 easily returns to the original shape by utilizing the elastic restoring force of the flexible member 204, and due to that reaction, the flowability of the liquid in the bag 202 can be improved.

### Eighth Embodiment

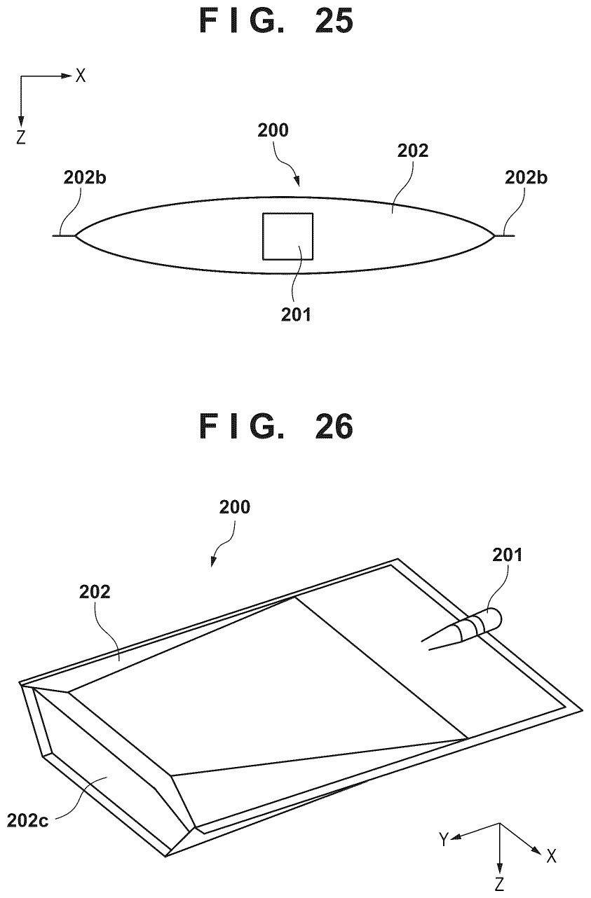

A container in which the bag 202 does not have a gusset portion 202a can also be adopted as the container 200. FIG. 25 illustrates an example thereof. The bag 202 is configured by fusing the upper and lower sheets at the peripheral portions 202b. The liquid contained in such a container 200 can also be mixed by the configuration described above.

### Ninth Embodiment

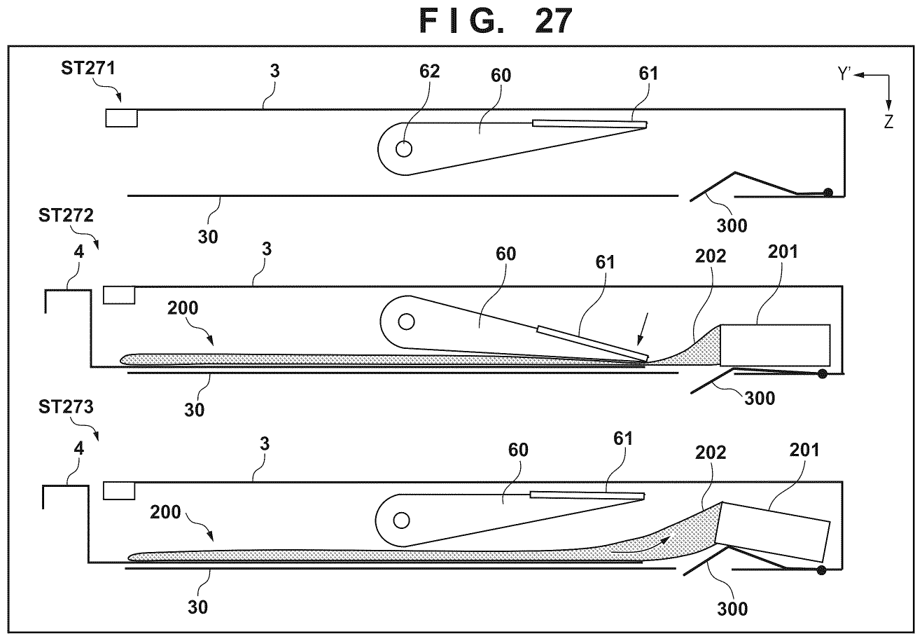

A displacement unit that displaces the position of the supply port 201a in the Z direction and promotes deformation of the container 200 may also be provided. The displacement unit may be configured by, for example, an elastic member. FIG. 27 illustrates an example in which a plate-shaped spring member 300 is provided in the slot 3. A state ST271 of FIG. 27 indicates a state of the slot 3 before the support unit 4 is mounted in the slot 3. The plate-like spring member 300 is provided in the case 30. The plate-like spring member 300 is a member that can be easily elastically deformed and generates a counterforce when pressed in the Z direction. The plate-shaped spring member 300 displaces the position of the outlet member 201 in the Z direction in conjunction with the operation in which the pressing member 60 presses the container 200, as described later.

A state ST272 of FIG. 27 indicates a state in which the support unit 4, with the container 200 mounted, is installed in the slot 3. An opening (not illustrated) that allows the plate-shaped spring member 300 to contact the container 200 is formed in the bottom portion of the support unit 4. The state ST272 of FIG. 27 also assumes a state in which the remaining amount of liquid in the bag 202 of the container 200 is low. The pressing member 60 (pressing portion 61) has moved to the pressing position, and the bag 202 is being pressed. The plate-shaped spring member 300 is in a state in which it is elastically deformed and bent in the Z direction.

A state ST273 of FIG. 27 indicates a state in which the pressing member 60 (pressing portion 61) has moved to a pressing reduced position, and the pressing on the bag 202 has been reduced. When the remaining amount of liquid in the bag 202 is low, the flow of liquid inside is also low. However, in the present embodiment, the plate-shaped spring member 300 returns, and the outlet member 201 is pushed up by its counterforce. It acts such that the end portion on the outlet member 201 side of the bag 202 expands upward. Liquid flows into the portion expanded by the bag 202 expanding, and a mixing effect can be generated.

Then, when the pressing member 60 (pressing portion 61) moves again to the pressing position, the liquid that has flowed into the end portion on the outlet member 201 side of the bag 202 is pressed by the pressing portion 61 and spreads around. Accordingly, the mixing effect of the liquid can be further improved.

In the example of FIG. 27, the bag 202 is expanded by the outlet member 201 being pushed up by the plate-shaped spring member 300, but is not limited thereto. Regarding the method of applying force, various methods such as pushing down, pulling, or twisting the outlet member 201 can be selected, and the outlet member 201 need only be displaceable.

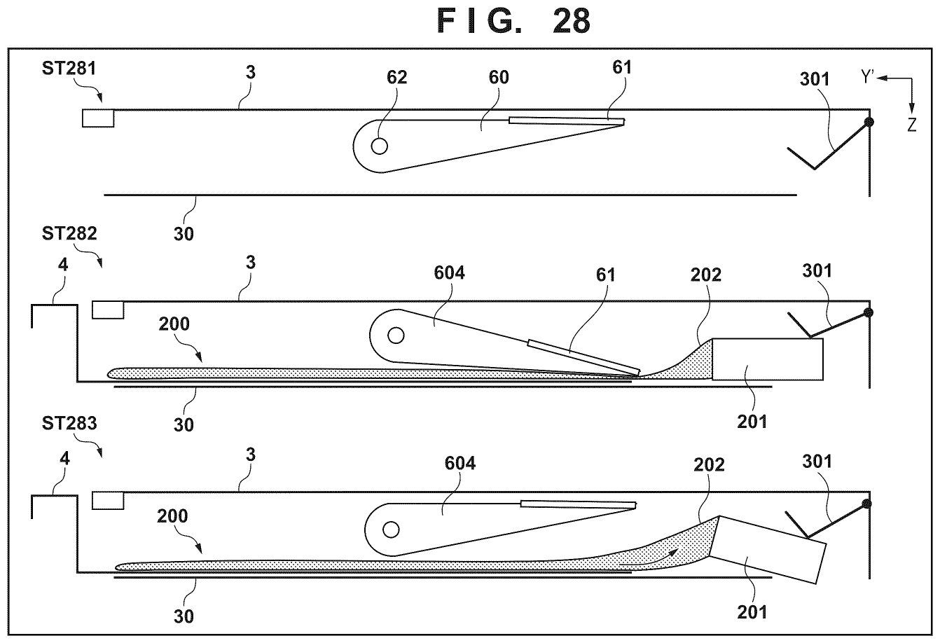

As one example, FIG. 28 illustrates a form in which the outlet member 201 is pushed down. Similarly to the state ST271 of FIG. 27, a state ST281 of FIG. 28 indicates a state of the slot 3 before the support unit 4 is set. Instead of the above plate-shaped spring member 300, a plate-shaped spring member 301 that bends in the −Z direction and generates a counterforce is provided.

Similarly to the state ST272 of FIG. 27, a state ST282 of FIG. 28 indicates a state in which the support unit 4, with the container 200 mounted, is mounted in the slot 3, and the pressing member 60 (pressing portion 61) has moved to the pressing position. The plate-shaped spring member 301 is bent in the −Z direction via the outlet member 201.

A state ST283 of FIG. 28 indicates a state in which the pressing member 60 (pressing portion 61) has moved to a pressing reduced position, and the pressing on the bag 202 has been reduced. The plate-shaped spring member 301 returns and generates a counterforce in the Z direction. The generated counterforce pushes down the outlet member 201, but the bag 202 side of the outlet member 201 is lifted, and the bag 202 expands similarly to the case of pushing up, as illustrated in FIG. 27. Liquid flows into the expanded portion, and the mixing of the liquid is promoted.

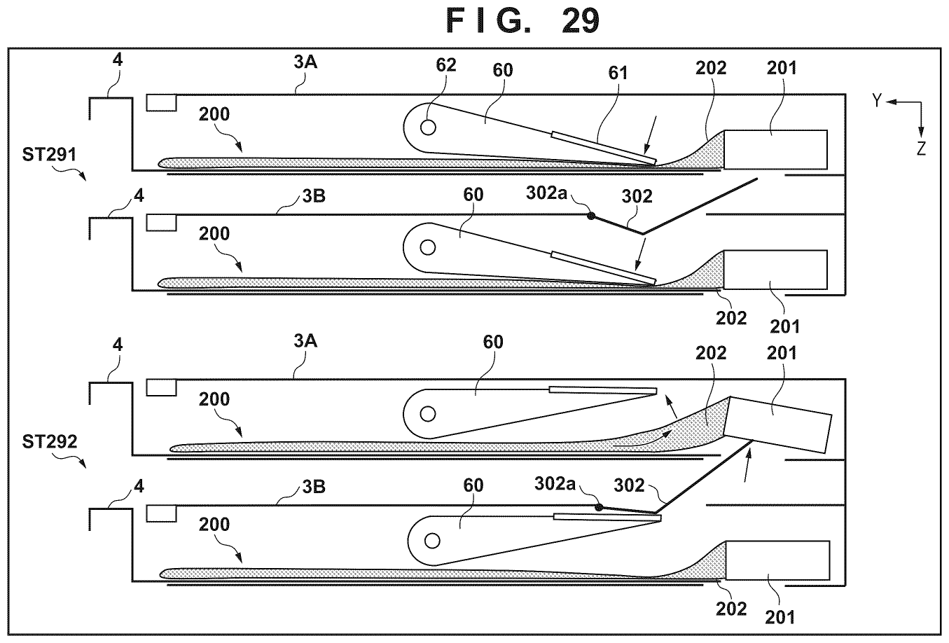

FIG. 29 illustrates an example of another configuration for moving the outlet member 201. In this configuration example, the configuration is such that the outlet member 201 of the container 200 mounted in a slot 3A, which is directly above, is pushed up by a lever member 302 provided in a lower slot 3B. The lever member 302 is rotatably attached to a shaft 302a in the X direction.

Regarding a state ST291 of FIG. 29, the pressing portion 61 has moved to the pressing position and is pressing the bag 202 of the container 200. The pressing member 60 and the lever member 302 are separated.

Regarding a state ST292 of FIG. 29, the pressing portion 61 has moved to the pressing reduced position and is separated from the bag 202. The pressing member 60 comes into contact with the lever member 302, and the lever member 302 is pushed up. The lever member 302 rotates about the axis 302a and pushes up the outlet member 201 of the container 200 mounted in the slot 3A. The bag 202 expands similarly to the case of pushing up, as illustrated in FIG. 27. Liquid flows into the expanded portion, and the mixing of the liquid is promoted.

### Tenth Embodiment

FIG. 26 illustrates an example of another container 200. In the illustrated example, a gusset portion 202c is formed only on one side of the end opposite to the outlet member 201 of the bag 202. In the case of this configuration of the container 200, by the gusset portion 202c expanding, the capacity of liquid to be stored increases on the gusset portion 202c side.

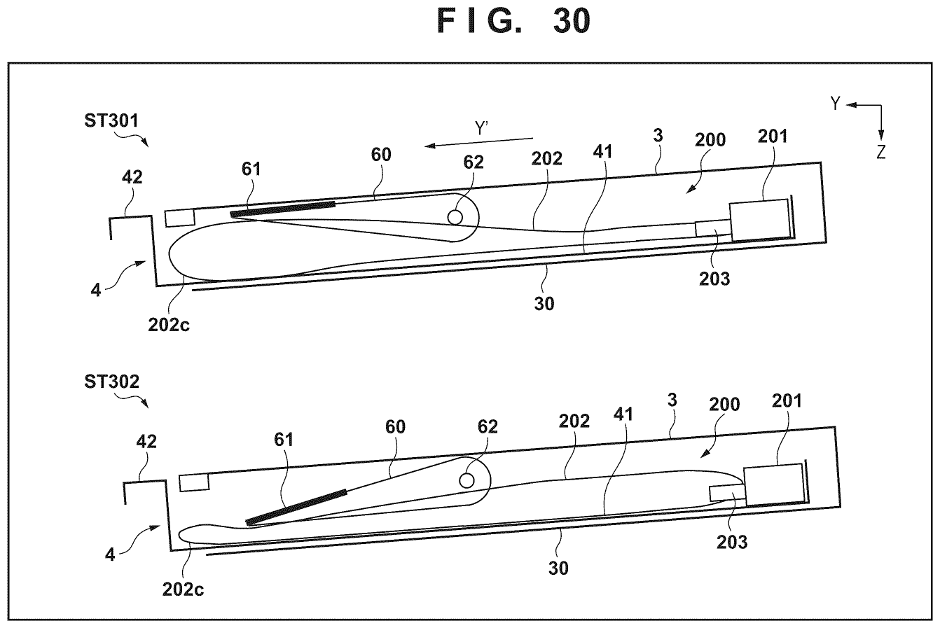

In the case of such a container 200, if the inclination of the slot 3 is reversed from that of the first embodiment, and the pressing member 60 is also arranged in the opposite direction, the most expanded portion of the container 200 is pressed, and a higher mixing effect can be obtained. FIG. 30 illustrates an example thereof. A state ST301 of FIG. 30 indicates a state in which the pressing member 60 (pressing portion 61) is positioned in the pressing reduced position, and a state ST302 of FIG. 30 indicates a state in which the pressing member 60 (pressing member 61) is positioned in the pressing position.

The slot 3 is inclined such that the +Y side is lower and the −Y side is higher. Accordingly, the support unit 4 is held in an inclined orientation in the mounted state, and the container 200 is positioned such that the end portion 200a is higher in the direction of gravity (Z direction) than the end portion 200b. The liquid stored in container 200 gathers on the gusset portion 202c side due to its own weight, and expands in that vicinity. The pressing member 60 is arranged such that the pressing portion 61 is positioned on the +Y side relative to the rotation shaft 62. The pressing portion 61 presses the expanded portion of the bag 202 near the gusset portion 202c.

In the pressing operation, the pressing member 60 rotates counterclockwise about the rotation shaft 62 as viewed in FIG. 30. Regarding the pressing operation, the pressing reduced operation, and the mixing effect, they are similar to those of the first embodiment.

### Eleventh Embodiment

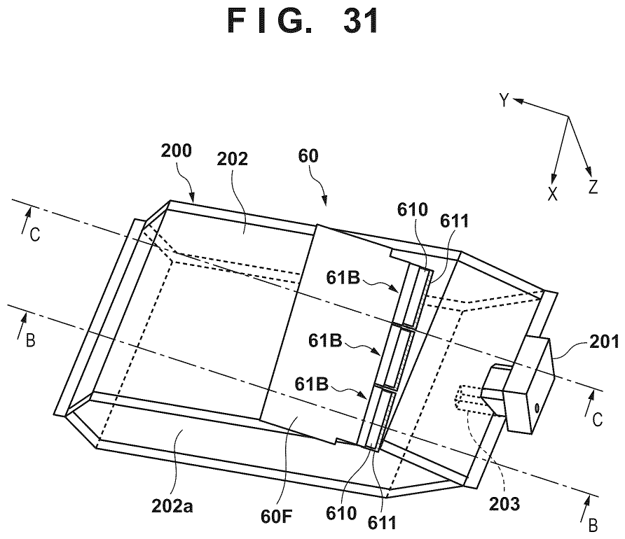

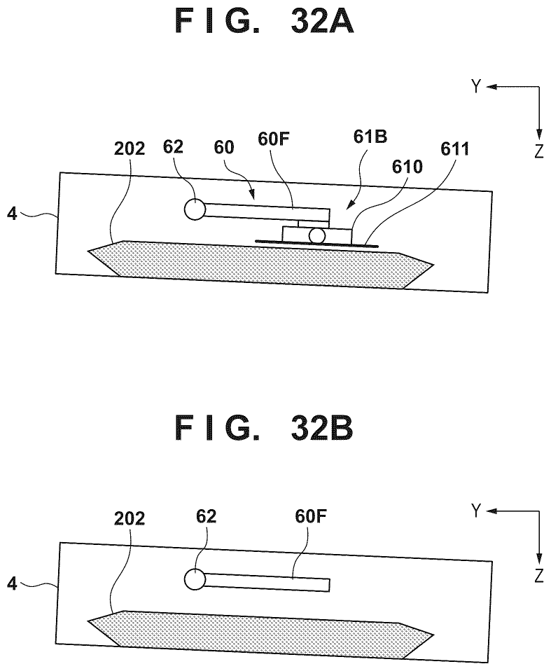

Each of a plurality of pressing portions may be independently movable so as to follow the surface shape of the container 200. FIG. 31 illustrates an example thereof. Further, FIGS. 32A and 32B are cross-sectional views taken along lines B-B and C-C of FIG. 31, respectively, and are schematic views.

The pressing member 60 includes a base member 60F and a plurality of pressing portions 61B supported by the base member 60F. The plurality of pressing portions 61B are arranged so as to be separated in the X direction.

The configuration of the pressing portions 61B is similar to the configuration of the pressing portion 61B in the fifth embodiment. In other words, the present embodiment has a structure in which a plurality of pressing portions 61B of the fifth embodiment are provided. Each pressing portion 61B is configured by the movable member 610, which is rotatably supported on the base member 60F via a rotation shaft 610a, and a flexible sheet 611 supported by the movable member 610. The movable member 610 is supported by the base member 60B via the rotation shaft 610a so as to be rotatable, and the sheet 611 is a member corresponding to the pressing portion 61A of the fourth embodiment. Each pressing portion 61B is independently rotatable about the rotation shaft 610a. Such a structure in which the pressing portion 61B rotates may be referred to as an equalizing structure.

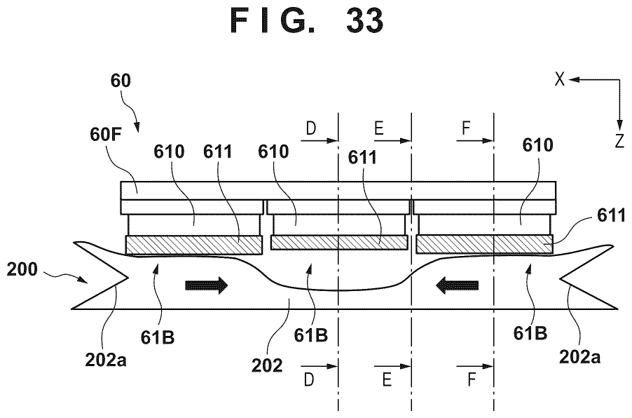

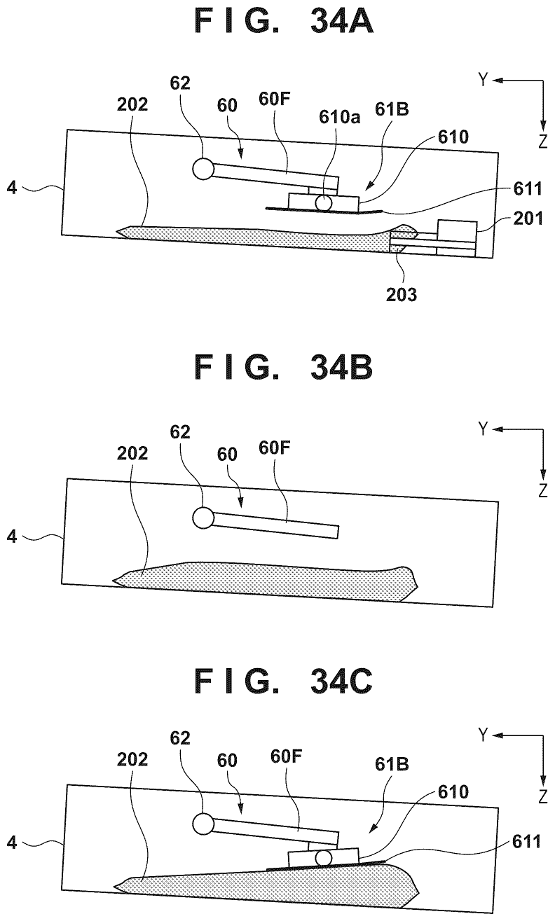

In the case of the present embodiment, a structure is such that, among the three pressing portions 61B, each of the two outer pressing portions 61B press the vicinity of the gusset portions 202a on a respective side surface of the bag 202, and the one inner pressing portion 61B presses the vicinity of the center of the bag 202. Here, a case where the protruded/recessed shape of the surface of the bag 202 that is used is significantly different depending on the portion, such as a case where the vicinity of the central portion of the bag 202 is recessed and both ends are protruded due to the gusset portions 202a, as in FIG. 33, is considered. In such a case, when pressing the bag 202, the two outer pressing portions 61B first come into contact with the bag 202, as shown in FIGS. 34A to 34C, and the bag 202 is pressed.

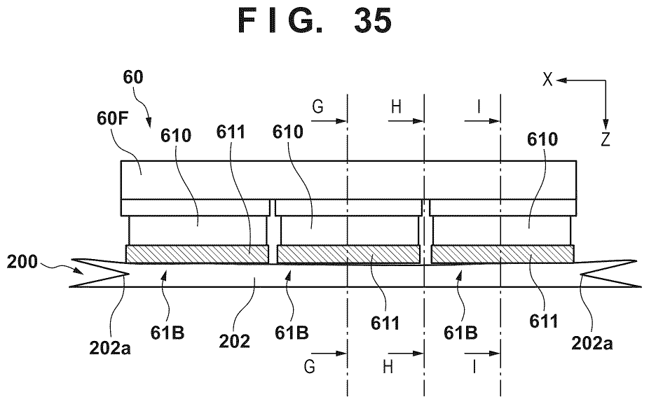

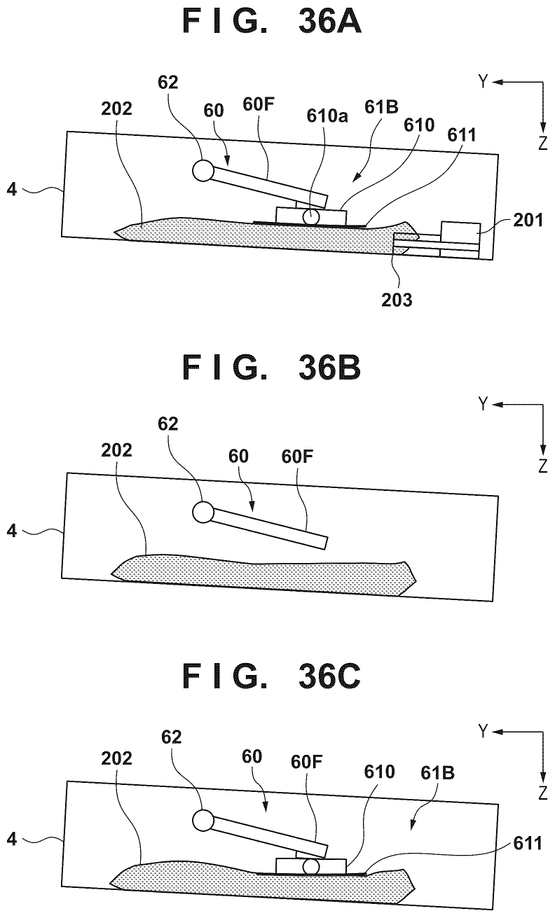

Then, as indicated by the arrows in FIG. 33, the liquid stored in the pressed portions flows into the central portion of the bag 202 in the X direction, and the surface shape near the center of the bag 202 changes. The shape after the change is illustrated in FIGS. 35 and 36A to 36C. FIGS. 36A to 36C are sectional views taken along lines G-G, H-H, and I-I of FIG. 35, respectively, and are schematic diagrams. As illustrated in FIGS. 36A to 36C, the vicinity of the central portion of the bag 202 comes into contact with the center pressing portion 61B, and since the pressing portion 61B comes into contact and presses in a manner that follows the surface shape of the bag 202, efficient mixing becomes possible. At this time, the movable member 610 of the center pressing portion 61B is equalized by rotating about the rotation shaft 610a independently of the movable members 610 arranged in other positions.

That is, as shown in the present embodiment, by providing an equalizing structure in which each of the plurality of pressing portions 61B rotates independently, it becomes possible to press the bag 202 across its surface regardless of the shape of the bag 202, even when the remaining amount in the container 200 is low.

In the present embodiment, three pressing portions 61B are provided as the plurality of pressing portions 61B, but the number of pressing portions 61B is not limited to this, and may be two or four or more.

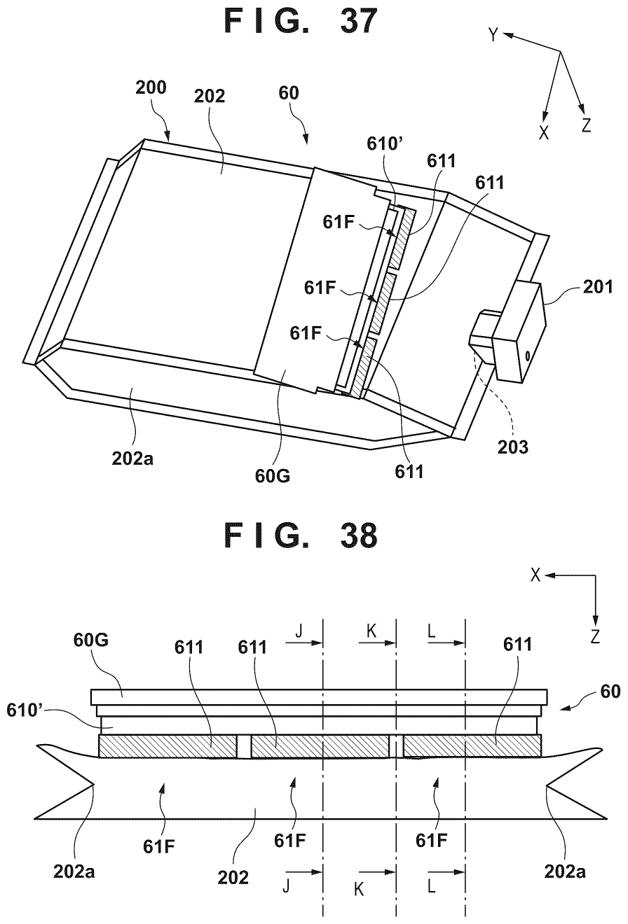

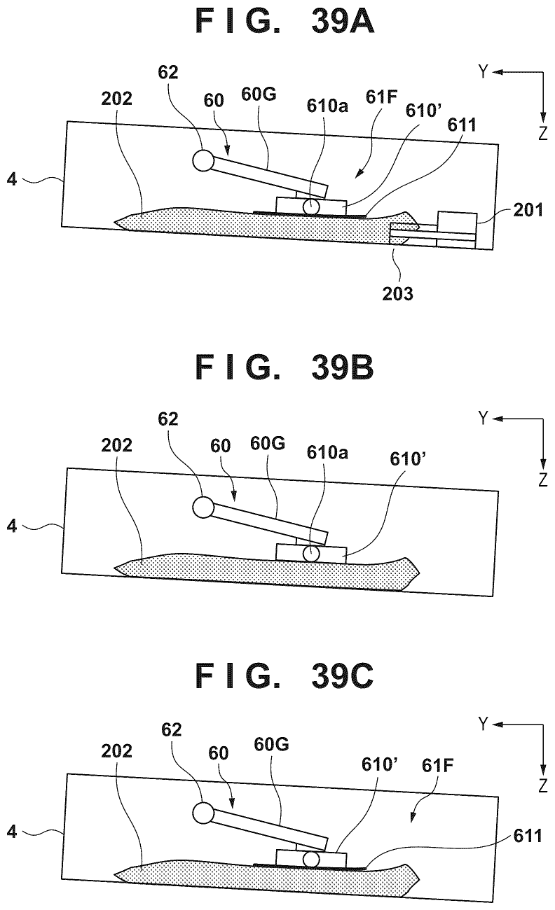

A different form of the equalizing structure will be described with reference to FIGS. 37 to 39C. FIG. 37 is a perspective view of the pressing member 60, and FIG. 38 is an explanatory diagram of pressing portions 61F. FIGS. 39A to 39C are sectional views taken along lines J-J, K-K, and L-L of FIG. 35, respectively, and are schematic diagrams.

In the present embodiment, pressing portions 61F for respective sheets 611 are configured by a single movable member 610′ supporting the plurality of sheets 611. When the protruded/recessed shape of the surface of the bag 202 is not significantly different depending on the portion, placing multiple flexible sheets 611 at the tip of a single equalizing structure, as in the present embodiment, can produce the same effect.

In the case of the present embodiment, unlike the eleventh embodiment, the surface of the bag 202 and the three pressing portions 61F come into contact substantially simultaneously, as illustrated in FIG. 38. In the present embodiment, since there is only one movable member 610′, that is, one equalizing structure, all the respective sheets 611 are equalized by the same amount.

When the liquid inside the bag 202 flows due to the pressing operation, changes occur in the surface shape of the bag 202. Also at this time, all the respective sheets 611 are equalized in the same manner along the surface shape of the bag 202. However, since each sheet 611 is flexible, the sheets 611 deform along the surface shape of the bag 202, and the bag 202 can be pressed across its surface. Therefore, if the surface shape of the bag 202 has relatively small differences in protrusion/recess, each pressing portion 61F is movable along that shape.

### Twelfth Embodiment

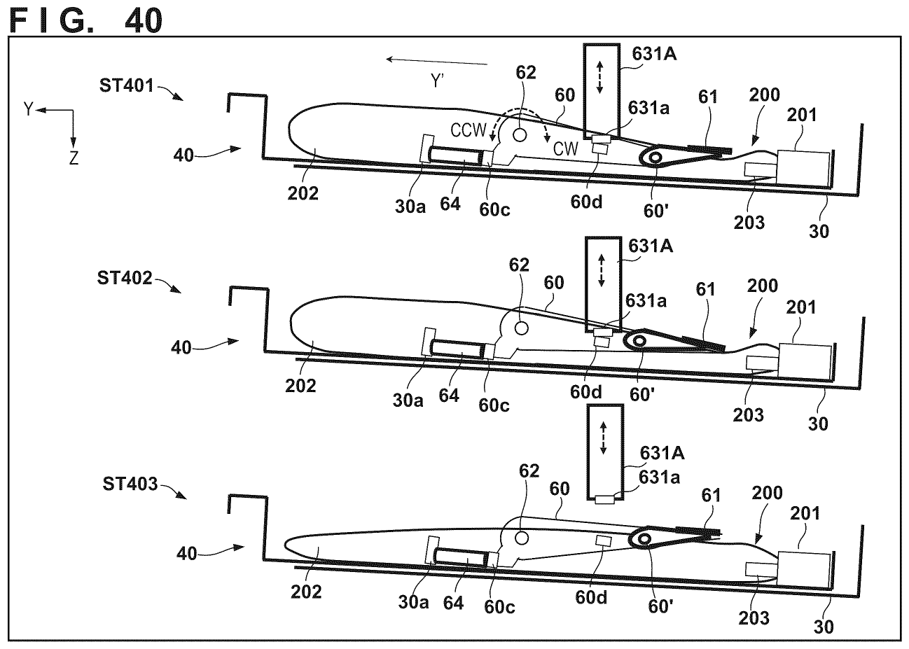

An example of another configuration of the pressing unit 6 will be described with reference to FIG. 40. FIG. 40 illustrates an example in which a portion of the configuration in the example of the configuration of FIG. 13B has been modified. The modifications are that the spring 64 is a compression spring, that the lifting member 631A acts to push down the pressing member 60, and that the pressing portion 61 of the pressing member 60 is configured as a movable arm that rotates about the shaft 60′.

The pressing member 60 is biased to rotate in the CCW direction by the compression spring 64. When the lifting member 631A lowers, the contact portion 631a of the lifting member 631A comes into contact with the contact portion 60d of the pressing member 60, and the pressing member 60 rotates in the CW direction.

A one-way torque limiter is arranged on the shaft 60′, and when a certain torque is applied towards the CCW side, the pressing portion 61 (movable arm) rotates in the CCW direction about the shaft 60′. The pressing portion 61 (movable arm) can rotate freely in the CW direction, and is able to rotate in the CW direction by its own weight.

A state ST401 represents a state in which the container 200 is being pressed. The pressing portion 61 is in a state in which it has come into contact with the container 200 at a position where a setting value of the torque limiter and the counterforce of the container 200 are balanced, and is in a state in which it has rotated in the CCW direction. Even when the remaining amount in the container 200 changes, pressing force corresponding to the setting value of the torque limiter is always applied to the container 200. Specifically, the stroke setting is such that, even when the remaining amount is in a minimum state, the lifting member 631A lowers to a position where the pressing portion 61 rotates in the CCW direction.

A state ST402 is a state in which the lifting member 631A is positioned higher than in the state ST401, and the pressing portion 61 has rotated in the CW direction under its own weight to a position in which comes into contact with a stopper (not illustrated). Regarding a state ST403, the lifting member 631A has lifted to a position separated from the pressing member 60. At this time, the pressing member 60 rotates in the CCW direction by the action of the compression spring 64, and the pressing portion 61 is separated from the container 200. Even when using such a configuration, even if the amount of contents of the container 200 changes, it is possible to press and mix the container 200 in a manner that follows that change.

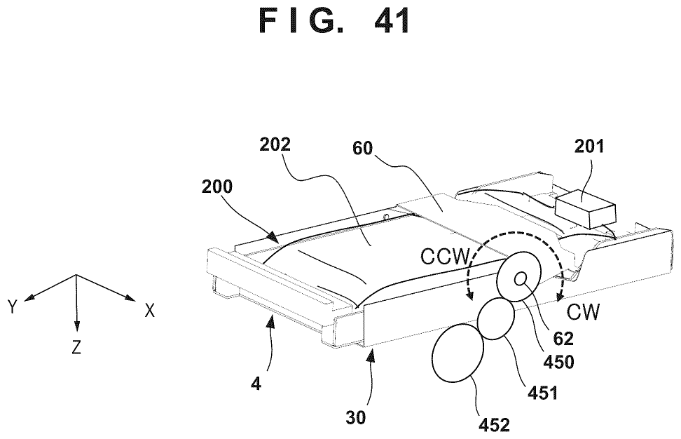

The form in which the pressing position follows the amount remaining in the container 200 can also be realized with a mechanism different from the mechanisms in FIGS. 13B and 40. FIG. 41 illustrates an example thereof.

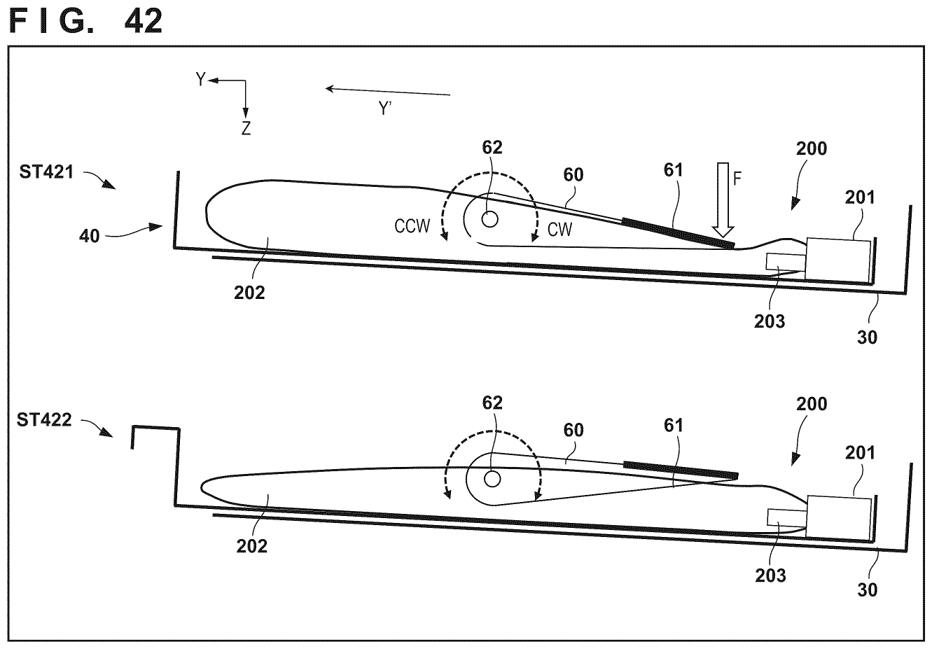

A gear 450 is connected to the pressing member 60 at a position coaxial with the rotation shaft 62, and a torque limiter is arranged inside the gear 450. Drive transmission is performed from a motor (not illustrated) to the gear 450 via gears 451 and 452, and by switching the rotation direction of the motor, the pressing member 60 can be rotated in the CW direction and the CCW direction. FIG. 42 is an explanatory view of the mixing operation.

When the pressing member 60 is rotated in the CW direction, the container 200 can be pressed as in a state ST421, and when rotated in the CCW direction, the pressing portion 61 can be separated from the container 200. The state ST421 represents a state in which the pressing portion 61 is pressing the container 200, and the pressing portion 61 is in a state in which it has come into contact with the container 200 at a position (pressing position) in which the setting value of the torque limiter and the counterforce of the container 200 are balanced. Even when the remaining amount in the container 200 changes, pressing force corresponding to the setting value of the torque limiter is always applied to the container 200. Specifically, the rotation amount is set such that, even when the remaining amount is in a minimum state, the motor rotates more than the pressing position of the pressing portion 61. In doing so, it is possible to apply the necessary pressing load to the container 200 and perform mixing.

According to the present invention, it is possible to provide a technique for improving uniformity of a liquid stored in a liquid container.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A liquid supply apparatus comprising:
a support unit configured to support a liquid container having flexibility;
a channel forming unit configured to be connected to the liquid container supported by the support unit, and form a channel through which liquid flows from the liquid container to a supply destination; and
a pressing unit configured to repeat a pressing operation and a pressing reduced operation with respect to the liquid container supported by the support unit.

2. The liquid supply apparatus according to claim 1, wherein
the pressing unit is configured to repeat the pressing reduced operation and the pressing operation with an interval between the pressing reduced operation and a next pressing operation.

3. The liquid supply apparatus according to claim 2, comprising:
a remaining amount detection unit configured to detect an amount remaining in the liquid container,
wherein the interval is changed based on a remaining amount detection result by the remaining amount detection unit.

4. The liquid supply apparatus according to claim 1, wherein
the support unit includes a placement surface on which liquid container is to be placed,
the pressing unit includes a pressing portion arranged so as to face the placement surface,
the pressing operation is an operation in which the pressing portion moves from a first position to a second position,
the pressing reduced operation is an operation in which the pressing portion moves from the second position to the first position,
the first position is a position that is separated from the placement surface than the second position, and
the second position is a position in which the liquid container is pressed towards a side of the placement surface.

5. The liquid supply apparatus according to claim 4, wherein
the first position is a position in which the pressing portion separates from the liquid container.

6. The liquid supply apparatus according to claim 4, wherein
the pressing unit includes a moving mechanism configured to move the pressing portion between the first position and the second position.

7. The liquid supply apparatus according to claim 4, comprising:
a position detection unit configured to detect a position of the pressing portion.

8. The liquid supply apparatus according to claim 4, wherein
the support unit is configured to be displaceable between a storage position in which the liquid container supported by the support unit is stored in a main body of the liquid supply apparatus and a removal position in which the liquid container supported by the support unit is exposed to outside of the main body,
the liquid supply apparatus comprises a lock unit configured to be capable of locking and unlocking the support unit with respect to the storage position,
wherein in a case where the lock unit is in an unlocked state, the pressing unit positions the pressing portion at the first position.

9. The liquid supply apparatus according to claim 4, wherein
the pressing portion is configured to be movably supported so as to follow a surface shape of the liquid container.

10. The liquid supply apparatus according to claim 4, wherein
the pressing unit includes a plurality of pressing portions, and
each pressing portion is configured to be individually and movably supported so as to follow a surface shape of the liquid container.

11. The liquid supply apparatus according to claim 10, wherein
the plurality of pressing portions are arranged in a width direction of the liquid container.

12. The liquid supply apparatus according to claim 9, wherein
the pressing portion is provided in a pressing member supported so as to be rotatable about an axis intersecting with a moving direction of the pressing portion.

13. The liquid supply apparatus according to claim 4, wherein
the pressing portion includes an elastic deforming portion configured to elastically deform so as to follow a surface shape of the liquid container.

14. The liquid supply apparatus according to claim 1, wherein
in a case where a pressing start condition is satisfied, the pressing unit is configured to repeat the pressing operation and the pressing reduced operation for a predetermined number of times.

15. The liquid supply apparatus according to claim 14, wherein
in a case where a change condition is satisfied, the predetermined number of times is changed.

16. The liquid supply apparatus according to claim 14, wherein
in a case where a change condition is satisfied, the pressing start condition is changed.

17. The liquid supply apparatus according to claim 1, wherein
in a case where a pressing start condition is satisfied, the pressing unit is configured to repeat the pressing operation and the pressing reduced operation for a predetermined number of times.

18. The liquid supply apparatus according to claim 1, wherein
the liquid container includes one end portion and the other end portion, and
a supply port to be connected to the channel forming unit is provided in the one end portion.

19. The liquid supply apparatus according to claim 18, wherein
the support unit is configured to support the liquid container such that the one end portion is lower than the other end portion.

20. The liquid supply apparatus according to claim 18, wherein
the pressing unit is configured to press a side of the one end portion relative to the other end portion.

21. The liquid supply apparatus according to claim 18, wherein
the support unit is configured to support the liquid container such that the one end portion is higher than the other end portion.

22. The liquid supply apparatus according to claim 21, wherein
the pressing unit is configured to press a side of the other end portion relative to the one end portion.

23. The liquid supply apparatus according to claim 21 wherein
the liquid container includes a gusset portion in the other end portion.

24. The liquid supply apparatus according to claim 1, wherein
the pressing unit is configured to repeat the pressing operation and the pressing reduced operation with respect to a most expanded portion of the liquid container.

25. The liquid supply apparatus according to claim 18, comprising:
displacing unit configured to displace the supply port in a direction of gravity.

26. The liquid supply apparatus according to claim 18, wherein
the liquid container includes a side portion in a width direction and between the one end portion and the other end portion, and
the side portion includes a gusset portion.

27. The liquid supply apparatus according to claim 26, wherein
the pressing unit is configured to press a center side relative to the gusset portion in the width direction.

28. The liquid supply apparatus according to claim 1, wherein
the supply destination is a liquid discharge apparatus that discharges the liquid onto a medium.

29. The liquid supply apparatus according to claim 1, wherein
a pressing height of the pressing unit changes according to a liquid remaining amount in the liquid container.

30. A method of controlling a liquid supply apparatus including a support unit configured to support a liquid container having flexibility, a channel forming unit configured to be connected to the liquid container supported by the support unit, and form a channel through which liquid flows from the liquid container to a supply destination, and a pressing unit configured to perform a pressing operation with respect to the liquid container supported by support unit, the method comprising:
repeating a pressing operation and a pressing reduced operation by the pressing unit.

31. A system comprising a liquid discharge apparatus that discharges liquid onto a medium and a liquid supply apparatus, wherein
the liquid supply apparatus comprises:
a support unit configured to support a liquid container having flexibility;
a channel forming unit configured to be connected to the liquid container supported by the support unit, and form a channel through which liquid flows from the liquid container to the liquid discharge apparatus; and
a pressing unit configured to repeat a pressing operation and a pressing reduced operation with respect to the liquid container supported by the support unit.
